(19) United States
(12) Patent Application Publication
(10) Pub. No.: US 2022/0161835 A1
(43) Pub. Date: May 26, 2022

(54) DEVICE FOR ASSISTING WITH THE DRIVING OF A WHEEL OF A REMOVABLE ELECTRIC PROPULSION SYSTEM FOR A ROLLING OBJECT

(71) Applicant: IFP Energies nouvelles, Rueil-Malmaison (FR)

(72) Inventors: Stephane VENTURI, RUEIL-MALMAISON CEDEX (FR); Elena SANZ, RUEIL-MALMAISON CEDEX (FR)

(21) Appl. No.: 17/432,623

(22) PCT Filed: Feb. 18, 2020
(86) PCT No.: PCT/EP2020/054140

§ 371 Date: Aug. 20, 2021

(30) Foreign Application Priority Data
Mar. 18, 2019 (FR) FR1902772

(51) Int. Cl. B62B 3/02; B62B 3/06; B62B 3/10; B62B 5/00; B62B 5/06; A61G 7/05

(52) U.S. Cl. CPC B62B 3/02; B62B 3/06; B62B 3/10; A61G 7/08; B62B 5/06; A61G 7/0528; B62B 5/0043

(57) ABSTRACT

The present invention relates to an electric propulsion system (1) for a rolling object, comprising a chassis (2) with at least one motorized wheel (3) and at least one non-motorized wheel (4), a handlebar (6), coupling means (5) and drive assist means. The coupling means are intended for gripping, orienting, immobilizing and lifting of at least one wheel (14) of rolling object 13). The drive assist means comprise at least one arm (36) of variable length for varying the distance between the at least one driven wheel (3) and the at least one non-driven wheel (4). The present application also concerns a coupled assembly comprising the electric propulsion system and a method of using the electric propulsion system.

### FIELD OF THE INVENTION

The invention relates to the field of transport of rolling objects, in particular rolling beds, hospital beds for example.

Moving rolling heavy loads can lead to difficulties for users, in particular if this action is repeated, such as musculoskeletal disorders.

### BACKGROUND OF THE INVENTION

In order to make the movement of rolling heavy loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and the battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling means provided for this propulsion system, the system cannot be universal and suitable for different rolling objects. Indeed, it cannot be coupled to a rolling object not provided with a coupling part. In addition, for this propulsion system, all the wheels of the rolling object remain in contact with the ground. Therefore, the orientation of the coupled assembly (propulsion system and bed) is more complicated, the frictional forces are high and the motorized wheel requires more power.

Patent application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift.

Patent application WO-2013/156,030 describes a third propulsion system for a hospital bed. The propulsion system is configured to lift two wheels of the bed. However, the system has great lateral (direction parallel to the axis of the motorized wheels) and longitudinal (direction perpendicular to the axis of the wheels) dimensions: the rear platform protrudes from the bed and the distance between the non-motorized wheels can exceed the dimensions of the bed, which may be inconvenient for moving the bed, in particular in a reduced space such as a hospital corridor or lift.

### SUMMARY OF THE INVENTION

In order to overcome these drawbacks, the present invention relates to an electric propulsion system/device for a rolling object, comprising a chassis with at least one motorized wheel and at least one additional wheel, preferably non-motorized, a handlebar and coupling means. The coupling means are intended for gripping, orienting, immobilizing and lifting of at least one wheel of the rolling load. Preferably, the means of orienting the wheel of the rolling object orient the wheel in a direction perpendicular to the longitudinal direction of the chassis. Thus, the movement of heavy rolling objects is made easy and ergonomic. Furthermore, the dimensions of the coupling means are reduced, in particular the lateral dimensions, and the propulsion system is more compact, which allows the rolling object to be moved, including in a reduced space. Moreover, these coupling means are universal and suitable for many types of rolling objects, because the rolling object requires no specific coupling means.

According to a first aspect, the invention relates to a removable electric propulsion system for a rolling object, the propulsion system comprising a chassis provided with at least one wheel driven by an electric machine, and at least one non-driven wheel, a handlebar and means for coupling the propulsion system to the rolling object, said coupling means comprising means for gripping, orienting, immobilizing and lifting at least one wheel of the rolling object, wherein: the gripping means comprise at least one set of two grasping elements whose principal axes are substantially perpendicular to the longitudinal axis of the chassis, the two grasping elements being adapted to come into contact with the wheel of the rolling object; the orienting means are adapted to orient the at least one wheel of the rolling object in a direction substantially perpendicular to the longitudinal direction of the chassis of the propulsion system.

According to one or more embodiments, the two grasping elements are adapted to allow insertion of the wheel of the rolling object between said grasping elements, in such a way that the axis of rotation of the wheel of the rolling object is substantially perpendicular to the principal axes of the two grasping elements.

According to one or more embodiments, the distance between the two grasping elements is predetermined so as to be strictly less than the diameter of the wheel of the rolling object, and greater than or equal to the thickness of the wheel of the rolling object.

According to one or more embodiments, one of the two grasping elements is longer than the other grasping element of the set of grasping elements, along the principal axes.

According to one or more embodiments, the grasping element arranged on the side of the motorized wheel is longer than the other grasping element of the set of two grasping elements.

According to one or more embodiments, a stop element is arranged on the inner side of the coupling means with respect to the grasping elements in a substantially perpendicular direction to the principal axes of the grasping elements, the stop elements being adapted to guide the wheel of the rolling object in such a way that said wheel abuts against the grasping element arranged on the side of the motorized wheel.

According to one or more embodiments, the stop element is arranged on a grasping element.

According to one or more embodiments, the distance between the stop element and a grasping element is predetermined so as to be strictly greater than the diameter of the wheel of the rolling object.

According to one or more embodiments, a moving part is connected to at least one grasping element through an axis of rotation perpendicular to the principal axis of the grasping element, the moving part being adapted to rotate about the axis of rotation and to extend the grasping element along the principal axis of the grasping element.

According to one or more embodiments, the principal axis of the moving part is vertical and the axis of rotation is parallel to the longitudinal direction of the chassis.

According to one or more embodiments, the moving part comprises a substantially horizontal principal axis parallel to the longitudinal direction of the chassis, said moving part being arranged on the side opposite to the adjacent grasping element, and comprising a vertical axis of rotation.

According to one or more embodiments, the moving part comprises an inner portion arranged on the side opposite the adjacent grasping element.

According to one or more embodiments, at least one of the wheels of the propulsion system comprises a braking system.

According to a second aspect, the invention relates to a removable electric propulsion system for a rolling object, the propulsion system comprising a chassis provided with at least one wheel driven by an electric machine, and at least one non- driven wheel, a handlebar and means for coupling the propulsion system to the rolling object, said coupling means comprising means for gripping, orienting, immobilizing and lifting at least one wheel of the rolling object, wherein: the orienting means are adapted to orient the at least one wheel of the rolling object in a direction substantially perpendicular to the longitudinal direction of the chassis of the propulsion system; and the immobilizing means comprise a substantially horizontal lashing arm carrying an immobilization element at one end thereof.

According to one or more embodiments, the immobilization element is oriented towards the outside of the chassis along the axis perpendicular to the longitudinal direction of the chassis, or the immobilization element is oriented towards the inside of the chassis along the axis perpendicular to the longitudinal direction of the chassis.

According to one or more embodiments, the immobilization element comprises a support element adapted to support the wheel of the rolling object by actuation of the lashing arm.

According to one or more embodiments, the support element comprises a flat piece, inclined or curved, adapted to pass under the wheel of the rolling object.

According to one or more embodiments, the support element comprises a spoon- shaped, shovel-shaped or L-shaped element.

According to one or more embodiments, the support element is adapted to pass under, support and immobilize the wheel of the rolling object.

According to one or more embodiments, the support element comprises a substantially horizontal part suited to pass under the wheel of the rolling object, and a substantially vertical part suited to come into contact with the wheel of the rolling object by actuation of the lashing arms.

According to one or more embodiments, a stop element is arranged on the lashing arm.

According to one or more embodiments, the stop element is adapted to guide the wheel of the rolling object so that said wheel can be placed between the stop element and the immobilization element.

According to one or more embodiments, the stop element is arranged on the inner side of the lashing arm with respect to the immobilization element.

According to one or more embodiments, two lashing arms are translatably movable along principal axes substantially parallel to one another, or two lashing arms are rotatably movable about respective vertical pivot axes.

According to one or more embodiments, the two lashing arms are set in motion with respect to one another by means of an actuator connected to each of said lashing arms, or the two lashing arms are set in motion by means of respective actuators connected to the chassis.

According to one or more embodiments, the gripping means comprise at least one set of two grasping elements whose principal axes are substantially perpendicular to the longitudinal direction of the chassis, the two grasping elements being adapted to come into contact with the wheel of the rolling object, said grasping elements being arranged at one end of said lashing arm.

According to a third aspect, the invention relates to a removable electric propulsion system for a rolling object, the propulsion system comprising a chassis provided with at least one wheel driven by an electric machine, and at least one non- driven wheel, a handlebar and means for coupling the propulsion system to the rolling object, said coupling means comprising means for gripping, orienting, immobilizing and lifting at least one wheel of the rolling object, wherein: the orienting means are adapted to orient the at least one wheel of the rolling object in a direction substantially perpendicular to the longitudinal direction of the chassis of the propulsion system; and the lifting means comprise an articulated structure in the central part of the chassis, between the at least one motorized wheel and the at least one non-motorized wheel.

According to one or more embodiments, the articulated structure comprises, on the one hand, a first chassis portion supported by the at least one motorized wheel and, on the other hand, a second chassis portion supported by the at least one non- motorized wheel.

According to one or more embodiments, said chassis portions are articulated with respect to one another about a horizontal axis of rotation substantially perpendicular to the longitudinal direction of the chassis.

According to one or more embodiments, immobilization elements adapted to immobilize the wheel of the rolling object are connected to the horizontal rotation shaft.

According to one or more embodiments, the horizontal rotation shaft is connected to lashing arms, the lashing arms being substantially horizontal and carrying at one end thereof the immobilization elements.

According to one or more embodiments, a first actuator is connected to each of the chassis portions and allows to control the position of one chassis portion with respect to the other.

According to one or more embodiments, the first actuator controls the height of the central part of the chassis comprising the horizontal rotation shaft.

According to one or more embodiments, the first actuator is adapted to move upward the horizontal rotation shaft by modifying an angle between the chassis portions at the horizontal rotation shaft.

According to one or more embodiments, the horizontal rotation shaft is arranged on a lower end of the chassis portions, and the angle is increased to move from a lower position to an upper position of the chassis portions.

According to one or more embodiments, the first actuator is connected, on the one hand, to a central portion of the first chassis portion and, on the other hand, to a rear end portion of the second chassis portion.

According to one or more embodiments, the first actuator is a single actuator and it is connected to a central portion of the chassis portions, in top view.

According to one or more embodiments, the first actuator is assisted by an additional actuator, each actuator being connected to a lateral end portion of the chassis portions, in top view.

According to one or more embodiments, the first actuator is a single actuator and it is connected to an end portion of the chassis portions, in top view.

According to one or more embodiments, the first actuator is adapted to: actuate, on the one hand, a crossed rod connected to a first end of the first actuator; and to actuate, on the other hand, an uncrossed rod connected to the second end of the first actuator, wherein one of said rods is connected along the longitudinal axis of the chassis to a central portion of the first chassis portion, and the other of said rods is connected along the longitudinal axis of the chassis to a rear end portion of the second chassis portion.

According to one or more embodiments, the first actuator is adapted to: actuate, on the one hand, a crossed rod connected to a first end of the first actuator through an element itself connected to a central portion of the first chassis portion; and to actuate, on the other hand, a non-crossed rod connected to the second end of the first actuator through the element itself connected to a central portion of the first chassis portion, wherein said rods are each connected along the longitudinal axis of the chassis, at the other end thereof, to a rear end portion of the second chassis portion.

According to a fourth aspect, the invention relates to a removable electric propulsion system for a rolling object, the propulsion system comprising a chassis provided with at least one wheel driven by an electric machine, and at least one non-driven wheel, a handlebar and means for coupling the propulsion system to the rolling object, said coupling means comprising means for gripping, orienting, immobilizing and lifting at least one wheel of the rolling object, the propulsion system further comprising: drive assist means comprising at least one arm of variable length adapted to vary the distance between the at least one driven wheel and the at least non-driven wheel.

According to one or more embodiments, the variable-length arm is, on the one hand, supported by the non-driven wheel and, on the other hand, connected to the chassis or connected to the coupling means carrying an immobilization element.

According to one or more embodiments, the extendable arm is, on the one hand, supported by the non-driven wheel and, on the other hand, connected to a non-motorized chassis portion.

According to one or more embodiments, the variable-length arm is substantially horizontal and comprises a principal axis substantially parallel to the longitudinal direction of the chassis.

According to one or more embodiments, an actuator is connected to said variable-length arm and to the non-motorized portion for varying the length of said variable-length arm.

According to one or more embodiments, the removable electric propulsion system comprises directional locking means adapted to lock/unlock the rotation of the non-motorized wheel about a vertical axis, and the directional movement of the non-motorized wheel is adapted to be left free during the actuation of the actuator.

According to one or more embodiments, the orienting means are adapted to orient the at least one wheel of the rolling object in a direction substantially perpendicular to the longitudinal direction of the chassis of the propulsion system.

According to one or more embodiments, the gripping means comprise at least one set of two grasping elements whose principal axes are substantially perpendicular to the longitudinal direction of the chassis, the two grasping elements being adapted to capture the wheel of the rolling object.

According to one or more embodiments, the immobilizing means comprise a substantially horizontal lashing arm carrying an immobilization element at one end thereof.

According to one or more embodiments, the variable-length arm is adapted to vary the distance between the at least one non-driven wheel and the lashing arm.

According to one or more embodiments, the variable-length arm is so adapted that the distance between the at least one non-driven wheel and the lashing arm can be modified by at least 150 mm.

According to one or more embodiments, the variable-length arm is so adapted that the distance between the at least one non-driven wheel and the lashing arm can be modified by a value ranging between 200 mm and 500 mm.

According to one or more embodiments of the aforementioned aspects, the lifting means comprise an articulated structure in the central part of the chassis, between the at least one motorized wheel and the at least one non-motorized wheel.

According to one or more embodiments of the aforementioned aspects, when said propulsion system is coupled to a rolling object, said non-driven wheels are arranged under said rolling object.

According to an implementation of the aforementioned aspects, when said propulsion system is coupled to a rolling object, said wheel driven by said electric machine is arranged outside said rolling object.

According to one or more embodiments of the aforementioned aspects, when said propulsion system is coupled to a rolling object, said wheel driven by said electric machine is arranged under the rolling object.

According to one or more embodiments of the aforementioned aspects, said chassis comprises a platform, notably for supporting a user.

According to one or more embodiments of the aforementioned aspects, when said propulsion system is coupled to a rolling object, said platform is arranged under said rolling object.

According to one or more embodiments of the aforementioned aspects, said handlebar is articulated with respect to the chassis about a horizontal axis.

According to one or more embodiments of the aforementioned aspects, said handlebar is articulated with respect to an orientation axis of said wheel driven about a horizontal axis, said orientation axis rotating with respect to the chassis about a vertical axis.

According to one or more embodiments of the aforementioned aspects, said non-driven wheels are orientable about a vertical axis, and they preferably are orientable off-centered wheels.

According to one or more embodiments of the aforementioned aspects, said non-driven wheels comprise a directional locking means.

According to one or more embodiments of the aforementioned aspects, said propulsion system comprises three or four wheels.

According to one or more embodiments of the aforementioned aspects, said rolling object is a rolling bed, a trolley, rolling furniture, a wheelchair.

According to one or more embodiments of the aforementioned aspects, said handlebar comprises means for controlling said electric machine and/or said coupling means.

According to one or more embodiments of the aforementioned aspects, said wheel driven by said electric machine is arranged at one end of said chassis opposite to the end of said chassis on which said non-driven wheels are arranged.

According to a fifth aspect, the invention relates to a coupled assembly comprising a rolling object and an electric propulsion system according to at least one of the aforementioned aspects, the rolling object being coupled to the electric propulsion system by said coupling means.

According to one or more embodiments, the electric propulsion system comprises directional locking means adapted to: unlock the rotation of the non-motorized wheel about a vertical axis in order to actuate the variable-length arm; and/or to lock the rotation of the non-motorized wheel about the vertical axis in order to move the coupled assembly.

According to a sixth aspect, the invention relates to a method for coupling a rolling object to an electric propulsion system according to at least one of the aforementioned aspects, comprising at least one of the following steps: contacting the wheel of the rolling object with at least one grasping element; orienting the wheel of the rolling object in a direction substantially perpendicular to the longitudinal direction of the chassis of the propulsion system; immobilizing the wheel of the rolling object with the immobilization element by actuating the lashing arm; and varying the distance between the at least one driven wheel and the at least one non-driven wheel by means of at least one variable-length arm.

### BRIEF DESCRIPTION OF THE FIGURES

Other features and advantages of the invention will be clear from reading the description hereafter of embodiments given by way of non-limitative example, with reference to the accompanying figures wherein:

FIG. 1 is a top view of a propulsion system according to one or more embodiments of the invention,

FIG. 2 is a side view of a propulsion system according to one or more embodiments of the invention,

FIG. 3 is a side view of a propulsion system according to one or more embodiments of the invention,

FIG. 4 is a top view of a propulsion system according to one or more embodiments coupled to a rolling object,

FIG. 5 is a side view of a propulsion system according to one or more embodiments of the invention ridden by a user,

FIG. 6A is a top view of a propulsion system according to one or more embodiments of the invention during gripping of a wheel of a rolling object,

FIG. 6B is a top view of a propulsion system according to one or more embodiments of the invention during the rotation of wheels of a rolling object about a vertical pivot axis,

FIG. 6C is a top view of a propulsion system according to one or more embodiments of the invention at the end of the rotation of wheels of a rolling object about a vertical pivot axis,

FIG. 6D is a top view of a propulsion system according to one or more embodiments of the invention during the immobilization of wheels of a rolling object,

FIG. 7A is a top view of a propulsion system according to one or more embodiments of the invention during gripping of a wheel of a rolling object,

FIG. 7B is a top view of a propulsion system according to one or more embodiments of the invention during the rotation of wheels of a rolling object about a vertical pivot axis,

FIG. 7C is a top view of a propulsion system according to one or more embodiments of the invention at the end of the rotation of wheels of a rolling object about a vertical pivot axis,

FIG. 7D is a top view of a propulsion system according to one or more embodiments of the invention during the immobilization of wheels of a rolling object,

FIG. 8A is a top view of a propulsion system according to one or more embodiments of the invention during gripping of a wheel of a rolling object,

FIG. 8B is a top view of a propulsion system according to one or more embodiments of the invention at the end of the rotation of wheels of a rolling object about a vertical pivot axis,

FIG. 8C is a top view of a propulsion system according to one or more embodiments of the invention during the immobilization of wheels of a rolling object,

FIG. 9A is a top view of a propulsion system according to one or more embodiments of the invention during gripping of a wheel of a rolling object,

FIG. 9B is a top view of a propulsion system according to one or more embodiments of the invention at the end of the rotation of wheels of a rolling object about a vertical pivot axis,

FIG. 9C is a top view of a propulsion system according to one or more embodiments of the invention during the immobilization of wheels of a rolling object,

FIG. 10A is a rear view of the means of coupling by internal gripping and ion of a propulsion system according to one or more embodiments of the invention before the sequence of immobilization of the wheels of a rolling object,

FIG. 10B is a rear view of the means of coupling by internal gripping and immobilization of a propulsion system according to one or more embodiments of the invention after the sequence of immobilization of the wheels of a rolling object,

FIG. 10C is a rear view of the means of coupling by external gripping and immobilization of a propulsion system according to one or more embodiments of the invention after the sequence of immobilization of the wheels of a rolling object,

FIG. 11A is a rear view of the means of coupling by internal gripping and immobilization of a propulsion system according to one or more embodiments of the invention after the sequence of immobilization of the left-oriented wheels of a rolling object,

FIG. 11B is a rear view of the means of coupling by internal gripping and immobilization of a propulsion system according to one or more embodiments of the invention after the sequence of immobilization of the right-oriented wheels of a rolling object,

FIG. 11C is a rear view of the means of coupling by internal gripping and immobilization of a propulsion system according to one or more embodiments of the invention after the sequence of immobilization of the wheels of a rolling object oriented in opposition,

FIG. 11D is a rear view of the means of coupling by internal gripping and immobilization of a propulsion system according to one or more embodiments of the invention after the sequence of immobilization of the wheels of a rolling object facing each other,

FIG. 12A is a 3D view of the coupling means of a propulsion system according to one or more embodiments of the invention,

FIG. 12B is a 3D view of the coupling means of a propulsion system according to one or more embodiments of the invention,

FIG. 12C is a 3D view of the coupling means of a propulsion system according to one or more embodiments of the invention,

FIG. 12D is a 3D view of the coupling means of a propulsion system according to one or more embodiments of the invention,

FIG. 12E is a 3D view of the coupling means of a propulsion system according to one or more embodiments of the invention,

FIG. 12F is a 3D view of the coupling means of a propulsion system according to one or more embodiments of the invention,

FIG. 12G is a 3D view of the coupling means of a propulsion system according to one or more embodiments of the invention comprising an inner portion of a bearing point,

FIG. 12H is a 3D view of the means of coupling by external gripping of a propulsion system according to one or more embodiments of the invention comprising a stop element arranged on a lashing arm,

FIG. 121 is a 3D view of the means of coupling by external gripping of a propulsion system according to one or more embodiments of the invention comprising a stop element arranged on a grasping element,

FIG. 13A is a side view of the lifting means of a propulsion system according to one or more embodiments of the invention in low position,

FIG. 13B is a side view of the lifting means of a propulsion system according to one or more embodiments of the invention in upper position,

FIG. 14A is a side view of the lifting means of a propulsion system according to one or more embodiments of the invention in low position,

FIG. 14B is a side view of the lifting means of a propulsion system according to one or more embodiments of the invention in upper position,

FIG. 15A is a side view of the lifting means of a propulsion system according to one or more embodiments of the invention in low position,

FIG. 15B is a 3D view of an embodiment of the lifting means of FIG. 15A,

FIG. 15C is a 3D view of an embodiment of the lifting means of FIG. 15A,

FIG. 15D is a side view of the lifting means of a propulsion system according to one or more embodiments of the invention in upper position,

FIG. 15E is a 3D view of an embodiment of the lifting means of FIG. 15D,

FIG. 15F is a 3D view of an embodiment of the lifting means of FIG. 15D,

FIG. 16A is a side view of the lifting means of a propulsion system according to one or more embodiments of the invention in low position,

FIG. 16B is a 3D view of an embodiment of the lifting means of FIG. 16A,

FIG. 16C is a side view of the lifting means of a propulsion system according to one or more embodiments of the invention in upper position,

FIG. 16D is a 3D view of an embodiment of the lifting means of FIG. 16C,

FIG. 17A is a top view of the drive assist means for means of coupling by internal gripping and immobilization of a propulsion system according to one or more embodiments of the invention in retracted position,

FIG. 17B is a top view of the drive assist means for means of coupling by internal gripping and immobilization of a propulsion system according to one or more embodiments of the invention in extended position,

FIG. 18A is a top view of the drive assist means for means of coupling by external gripping of a propulsion system according to one or more embodiments of the invention in retracted position, and

FIG. 18B is a top view of the drive assist means for means of coupling by external gripping of a propulsion system according to one or more embodiments of the invention in extended position.

### DETAILED DESCRIPTION OF THE INVENTION

The present invention relates to an electric propulsion system for a rolling object. An electric propulsion system is understood to be a removable system for assisting the movement of the rolling object in order to limit the forces required for the displacement of the rolling object. This electric propulsion system comprises at least one electric machine for driving it. A rolling object is an object comprising at least two wheels in order to move it.

The rolling object can have any shape, it can notably be a rolling bed, notably such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. Advantageously, at least one wheel, preferably two wheels of the rolling object are idle wheels, in other words, off-centered wheels orientable around a vertical axis. The rolling object is preferably non-motorized.

The electric propulsion system according to the invention comprises:
a chassis provided with at least one motorized wheel, i.e. a wheel driven by an electric machine, and at least one additional wheel, preferably two, preferably non- motorized, i.e. not driven by an electric machine,
a handlebar enabling handling, displacement and orientation of the propulsion system by a user,
means for coupling the propulsion system to a rolling object, the coupling means comprise means for gripping, orienting, immobilizing and lifting at least one wheel, preferably more wheels, and more preferably two wheels of the rolling object, in other words, the coupling means are configured to capture (e.g. grip, grasp, grab), orient, immobilize and lift at least one wheel of the rolling object.

Coupling is thus achieved with at least one wheel of the rolling object, preferably at least one idle wheel of the rolling object. Therefore, the rolling object does not need to be adapted for the electric propulsion system, which makes the electric propulsion system universal for various rolling objects.

According to one or more embodiments of the invention, the electric propulsion system can be configured in such a way that the non-motorized wheel(s) are located under the rolling object (either in a zone internal to the wheels of the rolling object, or in a zone external to the wheels of the rolling object and remaining under the rolling object) when the electric propulsion system is coupled to the rolling object. Thus, a part of the electric propulsion system does not protrude from the rolling object, which facilitates its use in reduced spaces.

According to one or more embodiments, the electric propulsion system can be configured in such a way that the motorized wheel is located outside the rolling object, along the longitudinal direction of the chassis, when the electric propulsion system is coupled to the rolling object. In other words, the part of the chassis supporting the motorized wheel protrudes from the rolling object in the longitudinal direction of the chassis when the electric propulsion system is coupled to the rolling object.

According to one or more embodiments, the electric propulsion system can be configured in such a way that the motorized wheel is located under the rolling object when the electric propulsion system is coupled to the rolling object. Thus, a part of the electric propulsion system does not protrude from the rolling object, which facilitates its use in reduced spaces.

According to one or more embodiments, the propulsion system can be configured in such a way that the major part of the propulsion system is located under the rolling object when the propulsion system is coupled to the rolling object. Only the part of the chassis corresponding to the motorized wheel and the handlebar protrude from the rolling object in the longitudinal direction of the chassis.

According to one or more embodiments, the propulsion system can comprise three or four wheels. When the propulsion system has three wheels, a single wheel can be driven by an electric machine. When the propulsion system has four wheels, two wheels can be driven by an electric machine.

According to one or more embodiments, the motorized wheel can be arranged at one longitudinal end of the chassis and the non-motorized wheels can be arranged at the other longitudinal end of the chassis.

The chassis can consist of a mechanic-welded assembly.

According to one or more embodiments, the coupling means are connected to the chassis between the motorized wheel and the non-motorized wheel(s). Thus, the longitudinal size of the propulsion system is limited. According to one or more embodiments, the coupling means are supported by the non-motorized wheels. Thus, the stability of the coupling means is increased.

Preferably, the coupling means can comprise adjusting means enabling adjustment along the longitudinal axis of the chassis. Therefore, their longitudinal position on the chassis may vary, which improves the flexibility of the removable electric propulsion system towards various rolling objects. The compactness of the system is also improved thereby. The adjusting means can be advantageously controlled by an operating device such as a remote control or a smartphone. A controller can also be used for example to receive user information (displacement of all the coupling means, or of a single coupling means, towards the front or the rear of the system) and to control adjustment of the coupling means.

The means for gripping the wheel of the rolling object allow the wheel to be grasped. For example, these gripping means can comprise a clamp system, a wedging system, magnetic means, adhesive means or any similar system. Advantageously, the gripping means can be movable so as to adapt to any wheel dimension and any wheel track. Movement of the gripping means can be achieved by means of one or more cylinders, for example electric cylinders, screw-nut systems, rack and pinion systems, or any similar means.

According to one or more embodiments, the gripping means comprise a first set of at least two grasping elements, such as rods or plates (e.g. metallic), preferably substantially horizontal, whose principal axes are substantially parallel to one another (preferably in a substantially horizontal plane) and perpendicular to the longitudinal direction of the chassis. According to one or more embodiments, the grasping elements are substantially horizontal and perpendicular to the longitudinal direction of the chassis. In the present application, a principal axis corresponds by default to the axis passing through the median part of the element considered in the largest dimension thereof. According to one or more embodiments, the two grasping elements are adapted to allow insertion of a wheel of the rolling object between said grasping elements, in such a way that the axis of rotation of the wheel is substantially perpendicular to the principal axes of the two grasping elements. According to one or more embodiments, the distance between the two grasping elements is predetermined to be: strictly less than the diameter of the wheel of the rolling object, such as less than 0.8 times, preferably between 0.3 and 0.5 times the diameter of the wheel of the rolling object; and greater than or equal to the thickness of the wheel of the rolling object, such as between 1 and 1.5 times, preferably between 1 and 1.2 times the thickness of the wheel of the rolling object. According to one or more embodiments, one grasping element is longer than the other grasping element of the set of grasping elements, in the direction substantially perpendicular to the longitudinal direction of said chassis. According to one or more embodiments, the grasping element arranged on the side substantially opposite to the direction of insertion of the electric propulsion system under the rolling object is longer than the other grasping element of the set of grasping elements. Preferably, the grasping element arranged on the side of the motorized wheel is longer than the grasping element arranged on the side of the non-motorized wheel(s). According to one or more embodiments, the grasping element arranged on the side of the motorized wheel is 1 to 2.5 times, such as 1.5 to 2 times as long as the grasping element arranged on the side of the non-motorized wheel(s). According to one or more embodiments, a stop element is arranged on the inner side of the coupling means with respect to the grasping elements (in a direction substantially perpendicular to the longitudinal direction of said chassis), the stop element being adapted to guide the wheel of the rolling object in such a way that said wheel abuts against the grasping element arranged on the side of the motorized wheel. According to one or more embodiments, the distance between the stop element and a grasping element is predetermined so as to be strictly greater than the diameter of the wheel of the rolling object. According to one or more embodiments, the distance between the stop element and the grasping element arranged on the side of the non-motorized wheel is predetermined so as to be strictly greater than the diameter of the wheel of the rolling object. According to one or more embodiments, the gripping means comprise a moving part connected to at least one grasping element through an axis of rotation perpendicular to the principal axis of the grasping element, the moving part being adapted to rotate about the axis of rotation and to extend the grasping element along the principal axis of the grasping element, notably when the wheel of the rolling object is inserted between the grasping elements.

According to one or more embodiments, the coupling means further comprise means for orienting the gripped (by the gripping means) wheel in a direction substantially perpendicular to the longitudinal direction of the chassis of the propulsion system (in other words, the wheel of the rolling object is oriented in a direction parallel to the lateral axis of the chassis). The longitudinal direction of the chassis is defined by the direction connecting the motorized wheel to the non-motorized wheel. The longitudinal direction corresponds to the principal direction of displacement of the electric propulsion system. Preferably, a substantially perpendicular direction is understood to be a direction forming an angle ranging between 80° and 100° relative to the longitudinal direction. Thus, upon propulsion of the rolling object, at least one wheel of the rolling object is gripped, oriented in a direction perpendicular to the longitudinal direction of the chassis, immobilized and lifted. The coupling means thus act in the direction of thickness of the wheels of the rolling object, and not in the direction of the diameter of the wheels. This contributes to ensuring that the coupling means have reduced lateral dimensions in relation to the lateral dimensions of the propulsion systems of the prior art (as described for example in patent applications WO-2012/171,079 and WO-2013/156,030), which facilitates their use in reduced spaces such as corridors and lifts. The means of orienting the wheel of the rolling object can be implemented through the displacement of the wheel gripping means.

Means of immobilizing the wheel of the rolling object allow the gripped (grasped, locked) wheel to be immobilized. For example, the immobilizing means can comprise a clamp system, a wedging system, magnetic means, adhesive means or any similar system. Advantageously, the immobilizing means can be movable so as to adapt to any wheel dimension and any wheel track. Movement of the immobilizing means can be achieved by means of one or more cylinders, for example electric cylinders, screw-nut systems, rack and pinion systems, or any similar means.

According to one or more embodiments, the immobilizing means are compact and simple, and they are designed to lash down to the wheels of the rolling object when they are oriented perpendicular to the longitudinal axis of the chassis (the wheels of the rolling object can be oriented in the same direction, whether to one side or another, but they can also be arranged in opposition or facing each other).

According to one or more embodiments, the immobilizing means comprise a first and a second substantially horizontal arm referred to as “lashing” arm, carrying each an immobilization element at one end thereof. According to one or more embodiments, each immobilization element is extended by two grasping elements (gripping means used for the gripping and orienting sequences). According to one or more embodiments, the lashing arms have principal axes referred to as “displacement axes”, substantially parallel to one another and preferably substantially coaxial. According to one or more embodiments, the two lashing arms are arranged in opposition on the electric propulsion system. According to one or more embodiments, each lashing arm is rotatably movable around a vertical pivot axis. According to one or more embodiments, the principal axis of a lashing arm forms, relative to the longitudinal axis of the chassis, an angle ranging between 70° and 45° in expanded position (i.e. before the immobilization sequence) and an angle ranging between 45° and 20° in retracted position (i.e. after the immobilization sequence). According to one or more embodiments, the principal axis of a lashing arm forms, relative to the longitudinal axis of the chassis, an angle substantially greater than 45° in expanded position (i.e. before the immobilization sequence) and an angle substantially smaller than 45° in retracted position (i.e. after the immobilization sequence).

According to one or more embodiments, the immobilization element is arranged between two grasping elements, in top view. According to one or more embodiments, the immobilization element comprises a support element (flat, inclined or curved piece adapted to pass under the wheel of the rolling object), for example spoon-shaped, shovel-shaped or L-shaped, notably adapted to support, then to immobilize the wheel of the rolling object by actuation of the lashing arm. According to one or more embodiments, the support element comprises a curve adapted to pass under the wheel of the rolling object. According to one or more embodiments, the support element comprises a substantially horizontal part notably adapted to pass under the wheel of the rolling object, and a substantially vertical part notably adapted to come into contact with said wheel upon actuation of the lashing arms.

According to one or more embodiments, each immobilization element is oriented towards the outside along an axis perpendicular to the longitudinal direction of the chassis (immobilization elements arranged in opposition). According to one or more embodiments, the lashing arms are spaced from one another by suitable systems such as one or more cylinders, until the wheels of the rolling object are immobilized by the immobilization elements. According to one or more embodiments, the immobilization elements are positioned opposite each other on the electric propulsion system. According to one or more embodiments, the lashing arms are moved closer to each other by means of suitable systems such as one or more cylinders, until the wheels of the rolling object are immobilized by the immobilization elements.

According to one or more embodiments, each lashing arm is movable with respect to the chassis (along the axis perpendicular to the longitudinal direction of the chassis, or by rotation about a vertical pivot axis) by means of a displacement component such as a cylinder, itself connected to said lashing arm and to said chassis. According to one or more embodiments, each lashing arm is set in motion in relation to each other by means of a component such as a cylinder, itself connected to each of said lashing arms, regardless of the position of the chassis. For example, when a first immobilization element of a first lashing arm comes into contact with, then abuts against a first wheel of the rolling object, it is the second immobilization element of the second lashing arm that moves until it comes into contact with and abuts against a second wheel of the rolling object. According to one or more embodiments, the lashing arms are set in motion independently of one another by means of components such as cylinders, each cylinder being connected to a lashing arm and to the chassis.

Compact and easy to use, the means for lifting the wheel(s) allow the wheel(s) of the rolling object to be elevated so that this wheel of the rolling object no longer touches the ground. The mass of the rolling object supported by this wheel is then transferred to the electric propulsion system. This notably provides the adhesion required for the motivity of the motorized wheel of the electric propulsion system. At the same time, securing the rolling object to the electric propulsion system provides the stability required for operation of the electric propulsion system, which is all the more useful as the track width of the electric propulsion system is reduced. Lifting can be achieved by means of one or more cylinders, for example electric cylinders, screw-nut systems, rack and pinion systems, or any similar means.

According to one or more embodiments, the lifting means comprise an articulated structure in the central part of the chassis (e.g. between the at least one motorized wheel and the at least one non-motorized wheel). The articulated structure comprises, on the one hand, a first chassis portion referred to as “motive portion” supported by at least one motorized wheel, and the motorized wheel can pivot about a vertical shaft integral with said motive portion, preferably non-concurrent with the axis of rotation of the motorized wheel, and it comprises, on the other hand, a second chassis portion referred to as “non-motorized portion” supported by at least one non-motorized wheel. According to one or more embodiments, said chassis portions are articulated with respect to one another about a horizontal axis of rotation, referred to as “articulation axis”, substantially perpendicular to the longitudinal direction of the chassis. According to one or more embodiments, the immobilization elements are arranged adjacent to the axis of rotation. According to one or more embodiments, the immobilization elements adapted to immobilize the wheel of the rolling object are directly or indirectly connected to the articulation axis. According to one or more embodiments, the articulation axis is arranged adjacent to the principal axes of the lashing arms. According to one or more embodiments, the articulation axis is directly or indirectly connected to lashing arms. According to one or more embodiments, a first actuator such as a cylinder, connected to each of the chassis portions, allows to control the position of one chassis portion with respect to the other. Therefore, the first actuator allows to control the height of the central part of the chassis comprising the horizontal axis of rotation and the principal axes of the lashing arms, and the distance between the lashing arms and the ground, and, as a result, lifting of the wheels of the rolling object in the immobilizing means.

According to one or more embodiments, prior to implementing the invention for immobilizing and lifting one or more wheels of the rolling object, a preliminary sequence of actuating the first actuator can be controlled so as to generate a substantially vertical movement towards the ground of the articulation axis present between the two chassis portions. The displacement axes of the lashing arms being located in a zone close to said articulation axis, the lashing arms also undergo a vertical displacement towards the ground. Advantageously, this preliminary sequence allows to pre-arrange the immobilization elements as close as possible to the ground so as to facilitate the immobilization sequence. According to one or more embodiments, the preliminary sequence can be carried out before the gripping sequence for pre-arranging the grasping elements at a height with respect to the ground substantially equal to the height with respect to the ground of the axis of rotation of the wheels of the rolling object.

According to one or more embodiments, the electric propulsion system can perform the following sequence of steps for coupling: gripping the wheel of the rolling object, orienting the wheel(s) of the rolling object in a direction perpendicular to the longitudinal direction of the chassis, immobilizing the wheel(s) of the rolling object and lifting the wheel(s) of the rolling object.

According to one or more embodiments, the electric propulsion system performs the gripping sequence by bringing the gripping means close to one of the wheels of the rolling object until the wheel of the rolling object is inserted between the two grasping elements, the axis of rotation of the wheel of the rolling object being perpendicular to the principal axis of the two grasping elements. According to one or more embodiments, the distance between the grasping elements and the ground during the gripping sequence is between 0.2 and 0.8 times the diameter of the wheel of the rolling object, preferably between 0.3 and 0.7 times the diameter of the wheel of the rolling object.

According to one or more embodiments, the electric propulsion system performs the orientation sequence by rotating the wheel of the rolling object around the contact point on the ground, while maintaining substantially contact between the gripping means and the wheel of the rolling object. Rotation of the wheel of the rolling object by the electric propulsion system (or by the hand of a user) around its point of contact with the ground, itself linked to the rolling object by a vertical axis of rotation that does not pass through said contact point, has the effect of causing a slight displacement of the rolling object. This displacement of the rolling object then causes rotation of a second wheel of the rolling object around its point of contact with the ground. The rotation of the second wheel is similar to that imposed on the first wheel by the electric propulsion system (Caddy™ effect). The rotation of the electric propulsion system is applied until said second wheel of the rolling object is in a direction substantially perpendicular to the longitudinal direction of said chassis of said propulsion system. According to one or more embodiments, the rotation of the electric propulsion system is applied until a second set of two grasping elements comes into contact with said second wheel of the rolling object, for example until the grasping element located on the side of the motorized wheel of the second set of two elements comes into contact with said second wheel of the rolling object. According to an embodiment, the rotation sequence starts when at least one grasping element contacts the wheel of the rolling object. Advantageously, it is not necessary for the wheel of the rolling object to be gripped to perform the orientation step: it is for example sufficient that at least one of the grasping elements can guide the wheel of the rolling object during the rotation sequence. During the rotation sequence, the directional movement of the non-motorized wheels of the structure is preferably left free.

According to one or more embodiments, the electric propulsion system performs the immobilization sequence by positioning the immobilization elements between the wheels (or outside the wheels) of the rolling object, along the same axis as said wheels to be secured to the electric propulsion system, and by being substantially or nearly in contact with the ground. According to one or more embodiments, the distance between the immobilization elements and the ground during the immobilization sequence is less than 0.2 times the diameter of the wheel of the rolling object, preferably between 0 and 0.05 times the diameter of the wheel of the rolling object. According to one or more embodiments, positioning the immobilization elements between the wheels, or outside the wheels, is achieved once the orientation sequence is completed, given that the immobilization elements are arranged between two grasping elements, in top view. According to one or more embodiments, the lashing arms are moved away from (or towards) each other (by translation along respective horizontal axes, or by rotation around respective vertical axes) by means of suitable systems (e.g. cylinders) until one of the immobilization elements of a lashing arm comes into contact with, then abuts against a wheel of the rolling object, and the other immobilization element of the other lashing arm comes into contact with, then abuts against the other wheel of the rolling object. According to one or more embodiments, the lashing arms are set in motion independently of one another, by means of components such as cylinders, each cylinder being connected to a lashing arm and to the chassis. According to one or more embodiments, the lashing arms are set in motion with respect to one another by means of components such as cylinders, each cylinder being connected to the two lashing arms and independent of the chassis. During the immobilization sequence, the directional movement of the non-motorized wheels of the structure is preferably left free.

According to one or more embodiments, the electric propulsion system performs the lifting sequence by actuating the first actuator so as to cause a substantially vertical upward displacement of the articulation axis by modifying an angle between the chassis portions at the articulation axis. The displacement axes of the lashing arms being located in a zone close to said articulation axis, the lashing arms also undergo a lifting displacement. Advantageously, this lifting sequence allows to lift the wheels of the rolling object secured to the electric propulsion system. During the lifting sequence, the directional movement of the non-motorized wheels of the structure is preferably left free.

According to one or more embodiments, the chassis can comprise a platform. The platform can be used for supporting a load, in particular a user. Preferably, this platform is positioned above the non-motorized wheels or between the non-motorized wheels. According to a variant of this embodiment, the electric propulsion system is configured in such a way that the platform is located under the rolling object when the electric propulsion system is coupled to the rolling object, which allows the dimensions of the electric propulsion system to be reduced. For this embodiment, the platform cannot be used as a load support when the electric propulsion system is coupled to a rolling object. For example, the platform can be used by a user for use of the propulsion system as an electric scooter when the electric propulsion system is not coupled to a rolling object, which facilitates users' movements between the displacements of two rolling objects. Alternatively, the platform can be used for moving loads when the propulsion system is not coupled to a rolling object.

According to one or more embodiments of the invention, the handlebar can be articulated with respect to the chassis along a horizontal shaft attached to the chassis. This horizontal axis may preferably be in the lateral direction of the chassis. Thus, the handlebar can pivot about a horizontal axis.

For these two handlebar position embodiments, the handlebar is integral with no wheel and the displacement of the propulsion system is achieved in a similar manner to the displacement of a trolley (such as a shopping trolley for example).

According to one or more embodiments, the motorized wheel can be orientable with respect to the chassis along a vertical orientation axis, preferably non-concurrent with the axis of rotation of the motorized wheel, and the handlebar can be articulated or attached to the vertical orientation shaft of the motorized wheel. In other words, the motorized wheel can pivot with respect to the chassis about a vertical orientation axis, and this rotation about the vertical axis can be controlled by the displacement of the handlebar. This embodiment substantially corresponds to the control of the displacement of a pallet truck type system.

In order to facilitate the displacement of the electric propulsion system by a user, the handlebar can have control means such as electric machine control means and/or coupling means control means. The electric machine control means allow to start, stop, adjust the speed and/or the torque of the electric assistance. The coupling means control means allow to control the gripping means for gripping the wheel(s) of the rolling object, control the means of lifting the wheel(s) of the rolling object and control the means of orienting the wheels of the rolling object. These controls may consist in displacements of the elements that make up the coupling means.

According to one or more embodiments of the invention, the handlebar can be telescopic, foldable and/or removable, so as to facilitate storage of the electric propulsion system by limiting the size thereof. This also allows to limit the size of the propulsion system coupled to a rolling object in a reduced space such as a lift.

According to one or more embodiments, when the propulsion system is coupled to the rolling object, the propulsion system is not necessarily controlled through the handlebar, control can also be performed by rolling object control means such as a handle, a handlebar, or similar means.

The electric propulsion system can further comprise an electric battery for powering the electric machine. The electric battery can be arranged on or under the chassis, for example at the longitudinal end of the chassis close to the motorized wheel, or at the longitudinal end of the chassis close to the non-motorized wheels. Alternatively, the battery can be arranged on the handlebar. Furthermore, the battery can be removable so as to facilitate charging or replacement thereof. Alternatively, the battery may not be removable.

According to one or more embodiments, the non-motorized wheels can be idle wheels, i.e. off-centered wheels orientable around a vertical axis. In other words, the non-motorized wheels can pivot with respect to the chassis about a vertical orientation axis, and the orientation axis of the wheel can be off-centered (non-concurrent) with respect to the vertical orientation axis.

According to one or more embodiments, the non-motorized wheels can be wheels orientable around a vertical axis in a non-off-centered manner. In other words, the non-motorized wheels can pivot with respect to the chassis about a vertical orientation axis, and the axis of rotation of the wheel is aligned with this vertical orientation axis (concurrent with the vertical orientation axis).

Preferably, for the embodiment where the non-motorized wheels are orientable around a vertical axis (off-centered or not), the electric propulsion system can comprise directional locking means that can prevent rotation of the non-motorized wheels around their vertical axis. Thus, control of the directional locking means can facilitate the displacement of the electric propulsion system. According to one or more embodiments, the directional locking means can be controlled when the electric propulsion system is coupled to a rolling object and when the wheels of the rolling object in contact with the ground are idle wheels. When coupled, the non-motorized wheels are preferably not locked by the directional locking means. When the electric propulsion system is not coupled to the rolling object, the directional locking means is preferably actuated.

The invention further relates to a coupled assembly made up of a rolling object such as a rolling bed and a propulsion system according to any one of the variant combinations described above. The rolling object is coupled to the propulsion system by the coupling means. In other words, at least one wheel of the rolling object is gripped, oriented perpendicular to the longitudinal direction of the chassis and lifted by the coupling means of the propulsion system.

According to one or more embodiments, the electric propulsion system further comprises drive assist means for assisting users in handling the coupled assembly. According to one or more embodiments, the drive assist means comprise at least a third arm of variable length, referred to as “extendable” arm, adapted to control the distance between the at least one driven wheel and the at least one non-driven wheel. According to one or more embodiments, the extendable arm is adapted to control the distance between the at least one non-driven wheel and the lashing arms. According to one or more embodiments, the extendable arm is, on the one hand, supported by the non-driven wheel and, on the other hand, connected to the non-motorized portion. According to one or more embodiments, the extendable arm is substantially horizontal and it comprises a principal axis substantially parallel to the longitudinal direction of the chassis. According to one or more embodiments, the extendable arm is movable with respect to the non-motorized portion (along the axis parallel to the longitudinal direction of the chassis) by means of a second actuator such as a cylinder, itself connected to said extendable arm and to the non-motorized portion. According to one or more embodiments, the extendable arm is adapted so that the distance between the at least one non-driven wheel and the lashing arms can be increased by at least 150 mm, preferably between 200 and 500 mm. Advantageously, the at least one non-driven wheel thus displaced towards the central part of the rolling object provides increased maneuverability, referred to as “5th wheel effect”, notably upon rotation and/or displacement of the coupled assembly in cramped rooms and/or corridors, especially when the directional movement of said non-driven wheel is locked.

According to one or more embodiments, the electric propulsion system performs a drive assist sequence by actuating the second actuator so as to move the extendable arm and to increase the distance between the at least one non-driven wheel and the lashing arms. Preferably, the directional movement of the non-motorized wheels of the structure is preferably left free during the actuation of the actuator.

Preferably, the drive assist sequence is carried out before the lifting sequence. It is understood that the drive assist sequence can be carried out independently of the aforementioned sequences.

According to one or more embodiments, at least one of the wheels of the electric propulsion system comprises a braking system. According to one or more embodiments, at least one of the non-motorized wheels comprises a braking system. Advantageously, braking of one of the non-motorized wheels associated with driving of the motorized wheel allows the user to turn the coupled assembly effortlessly.

According to one or more embodiments, when the electric propulsion system is coupled to the rolling object, the electric propulsion system performs a directional movement locking sequence as follows. Case 1: the directional movement of the non-motorized wheels of the electric propulsion system is preferably left free, and the directional movement of at least one of the wheels of the bed is preferably locked, preferably one of the wheels farthest from the electric propulsion system. Case 2: the directional movement of at least one of the non-motorized wheels of the electric propulsion system is preferably locked, and the directional movement of all the wheels of the rolling object is preferably left free. Preferably, when the drive assist sequence is achieved, the electric propulsion system performs the directional movement locking sequence referred to as “Case 2”.

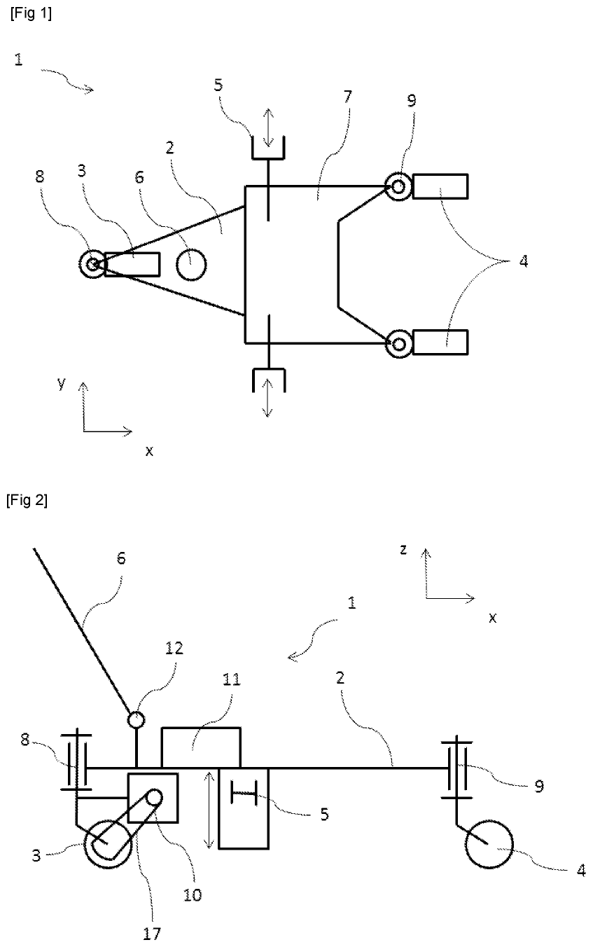

FIG. 1 schematically illustrates, by way of non-limitative example, an electric propulsion system according to one or more embodiments of the invention. FIG. 1 is a top view of electric propulsion system 1. Electric propulsion system 1 comprises a chassis 2. Axis x corresponds to the longitudinal axis of chassis 2 and to the principal direction of displacement of propulsion system 1, and axis y corresponds to the lateral axis of chassis 2. Chassis 2 supports three wheels (alternatively, chassis 2 may comprise four wheels). Chassis 2 supports a motorized wheel 3 (alternatively, chassis 2 may support two wheels 3), which is a wheel driven by an electric machine (not shown). Motorized wheel 3 is orientable with respect to chassis 2, around a vertical axis 8. At the other end, chassis 2 supports two non-motorized wheels 4, which are two wheels that are not driven by an electric machine. Non-motorized wheels 4 are orientable with respect to the chassis around vertical axes 9. Electric propulsion system 1 further comprises coupling means 5. According to the embodiment illustrated, electric propulsion system 1 comprises two coupling means 5 on either side of the chassis in the lateral direction (axis y) in order to achieve coupling by means of two wheels of the rolling object (not shown). Coupling means 5 are shown in a simplified manner as a clamp. The lateral displacement of the coupling means is shown by a double arrow. This lateral displacement can serve for gripping and orienting the wheels of the rolling object. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to chassis 2. Besides, electric propulsion system 1 comprises a supporting platform 7 (for supporting a user for example). Platform 7 is arranged at the end of chassis 2 supporting non-motorized wheels 4.

FIG. 2 schematically illustrates, by way of non-limitative example, an electric propulsion system according to one or more embodiments of the invention. FIG. 2 is a side view of electric propulsion system 1. Electric propulsion system 1 comprises a chassis 2. Axis x corresponds to the longitudinal axis of chassis 2 and to the principal direction of displacement of the propulsion system, and axis z corresponds to the vertical axis of chassis 2. The chassis supports three wheels. Chassis 2 supports a motorized wheel 3, which is a wheel driven by an electric machine 10 by means of a drive 17, a belt or a chain for example (alternatively, electric machine 10 may be directly connected to motorized wheel 3). Motorized wheel 3 is orientable with respect to chassis 2, around a vertical axis 8. Electric machine 10 can be integral with pivot 8 of motorized wheel 3. At the other end, chassis 2 supports two non-motorized wheels 4, which are two wheels that are not driven by an electric machine. Non-motorized wheels 4 are orientable with respect to the chassis, around vertical axes 9. Electric propulsion system 1 further comprises coupling means 5. According to the embodiment illustrated, electric propulsion system 1 comprises two coupling means 5 on either side of the chassis in the lateral direction (axis y) in order to achieve coupling by means of two wheels of the rolling object (not shown). Coupling means 5 are shown in a simplified manner as a clamp. The vertical displacement of coupling means 5 is shown by a double arrow. This vertical displacement of the coupling means notably allows the wheels of the rolling object to be lifted. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to chassis 2 by means of a joint 12 of horizontal axis, in the lateral direction of chassis 2 (perpendicular to the plane of the figure). Besides, electric propulsion system 1 comprises a battery 11. Battery 11 is arranged on chassis 2 close to electric machine 10 and motorized wheel 3.

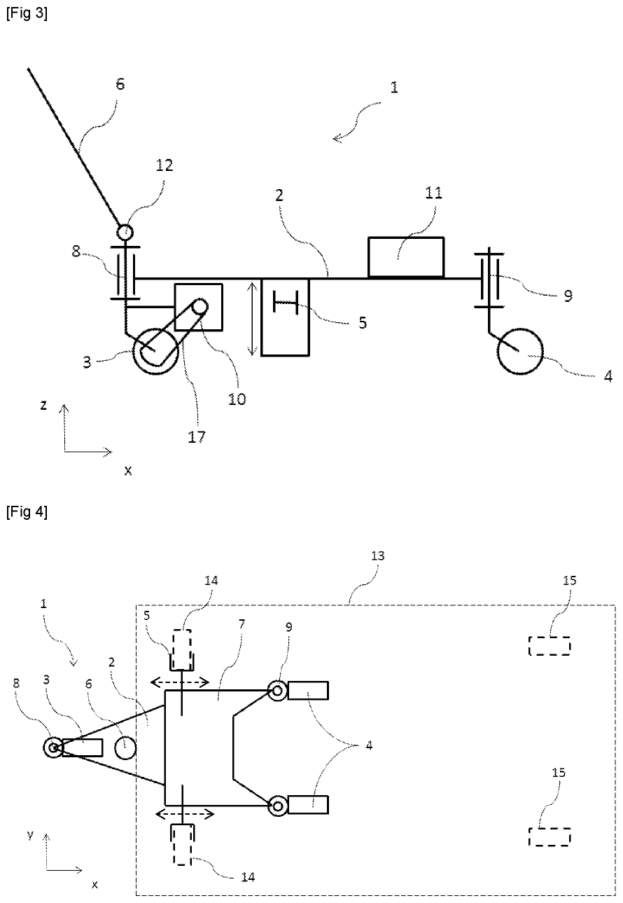

FIG. 3 schematically illustrates, by way of non-limitative example, an electric propulsion system according to one or more embodiments of the invention. FIG. 3 is a side view of electric propulsion system 1. Electric propulsion system 1 comprises a chassis 2. Axis x corresponds to the longitudinal axis of chassis 2 and to the principal direction of displacement of the propulsion system, and axis z corresponds to the vertical axis of chassis 2. The chassis supports three wheels. Chassis 2 supports a motorized wheel 3, which is a wheel driven by an electric machine 10 by means of a drive 17, a belt or a chain for example. Motorized wheel 3 is orientable with respect to chassis 2, around a vertical axis 8. Electric machine 10 can be integral with pivot 8 of motorized wheel 3. At the other end, chassis 2 supports two non-motorized wheels 4, which are two wheels that are not driven by an electric machine. Non-motorized wheels 4 are orientable with respect to the chassis, around vertical axes 9. Electric propulsion system 1 further comprises coupling means 5. According to the embodiment illustrated, electric propulsion system 1 comprises two coupling means 5 on either side of the chassis in the lateral direction (axis y) in order to achieve coupling by means of two wheels of the rolling object (not shown). Coupling means 5 are shown in a simplified manner as a clamp. The vertical displacement of coupling means 5 is shown by a double arrow. This vertical displacement of the coupling means notably allows the wheels of the rolling object to be lifted. Coupling means 5 are arranged, in direction x, between motorized wheel 3 and non-motorized wheels 4. Furthermore, propulsion system 1 comprises a handlebar 6, for example in form of a rod equipped with a handle (not shown) articulated with respect to vertical orientation axis 8 of motorized wheel 3 by means of a joint 12 of horizontal axis, parallel to the axis of rotation of the motorized wheel. Besides, electric propulsion system 1 comprises a battery 11. Battery 11 is arranged on chassis 2 close to non-motorized wheels 4.

FIG. 4 schematically illustrates, by way of non-limitative example, an electric propulsion system according to one or more embodiments of the invention coupled to a rolling object 13. FIG. 4 is a top view of electric propulsion system 1 and of rolling object 13. The embodiment of FIG. 4 corresponds to the embodiment of FIG. 1. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a chassis 2. Axis x corresponds to the longitudinal axis of chassis 2 and to the principal direction of displacement of the propulsion system, and axis y corresponds to the lateral axis of chassis 2. The chassis supports three wheels. Chassis 2 supports a motorized wheel 3, which is a wheel driven by an electric machine (not shown). Motorized wheel 3 is orientable with respect to chassis 2, around a vertical axis 8. At the other end, chassis 2 supports two non-motorized wheels 4, which are two wheels that are not driven by an electric machine. Non-motorized wheels 4 are orientable with respect to the chassis around vertical axes 9. Electric propulsion system 1 further comprises coupling means 5. According to the embodiment illustrated, electric propulsion system 1 comprises two coupling means 5 on either side of the chassis in the lateral direction (axis y) in order to achieve coupling by means of two rear wheels 14 of the rolling object. Coupling means 5 are shown in a simplified manner as a clamp. Rear wheels 14 of the rolling object are arranged in the clamp and oriented along axis y, i.e. an axis perpendicular to the longitudinal axis (axis x) of chassis 2. Furthermore, front wheels 15 of the rolling object are free and not coupled. Electric propulsion system 1 also comprises a handlebar 6, for example in form of a rod equipped with a handle (not shown) articulated with respect to chassis 2. Besides, electric propulsion system 1 comprises a supporting platform 7 (for supporting a user for example). Platform 7 is arranged at the end of chassis 2 supporting non-motorized wheels 4. For the embodiment of FIG. 4, coupling means 5, non-motorized wheels 4, platform 7 and a major part of chassis 2 are located under the rolling object. Only motorized wheel 3 and handlebar 6 can protrude from rolling object 13 in the longitudinal direction x of chassis 2.

In this figure, the double dashed arrows indicate that coupling means 5 can move longitudinally along an axis parallel to axis x, so as to come close to driven wheel 3 or, on the contrary, to come close to non-driven wheels 4. According to a variant, the coupling means can move independently of one another.

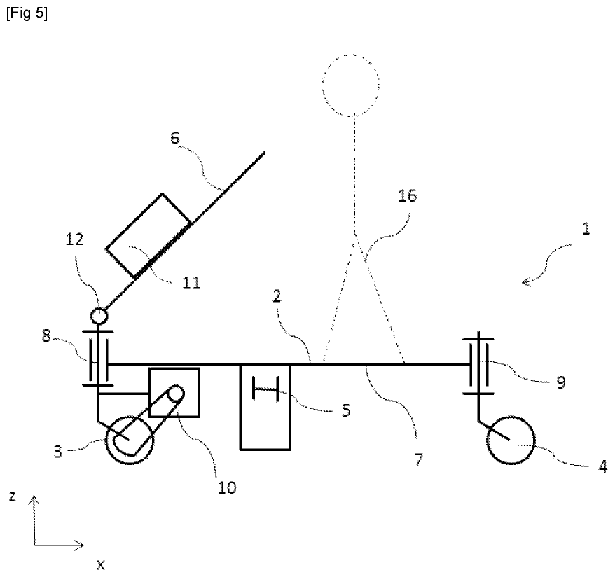

FIG. 5 schematically illustrates, by way of non-limitative example, an electric propulsion system according to one or more embodiments of the invention, electric propulsion system 1 being used as a scooter by a user 16. FIG. 5 is a side view of propulsion system 1. The propulsion system of FIG. 5 substantially corresponds to the propulsion system of FIG. 3. Electric propulsion system 1 comprises a chassis 2. Axis x corresponds to the longitudinal axis of chassis 2 and to the principal direction of displacement of the propulsion system, and axis z corresponds to the vertical axis of chassis 2. The chassis supports three wheels. Chassis 2 supports a motorized wheel 3, which is a wheel driven by an electric machine 10 by means of a drive 17, a belt or a chain for example. Motorized wheel 3 is orientable with respect to chassis 2, around a vertical axis 8. Electric machine 10 can be integral with pivot 8 of motorized wheel 3. At the other end, chassis 2 supports two non-motorized wheels 4, which are two wheels that are not driven by an electric machine. Non-motorized wheels 4 are orientable with respect to the chassis, around vertical axes 9. Electric propulsion system 1 further comprises coupling means 5. According to the embodiment illustrated, electric propulsion system 1 comprises two coupling means 5 on either side of the chassis in the lateral direction (axis y) in order to achieve coupling by means of two wheels of the rolling object (not shown). Coupling means 5 are shown in a simplified manner as a clamp. Coupling means 5 are arranged, in direction x, between motorized wheel 3 and non-motorized wheels 4. Furthermore, electric propulsion system 1 comprises a handlebar 6, for example in form of a rod equipped with a handle (not shown) articulated with respect to pivot 8 by means of a joint 12 of horizontal axis, parallel to the axis of rotation of the motorized wheel. Besides, electric propulsion system 1 comprises a battery 11. Battery 11 is arranged on handlebar 6. Chassis 2 comprises, at the longitudinal end thereof close to non-motorized wheels 4, a platform 7. For the illustrated use of the non-coupled electric propulsion system 1, the electric propulsion system is used as a scooter by user 16: the user stands on platform 7 and holds and/or actuates handlebar 6.

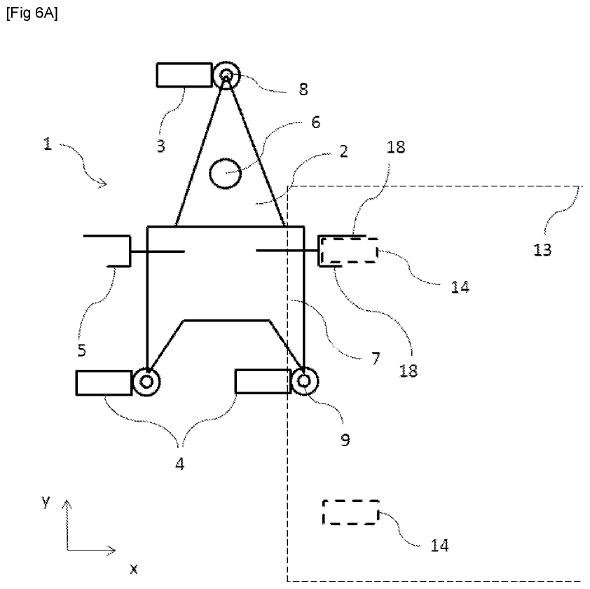

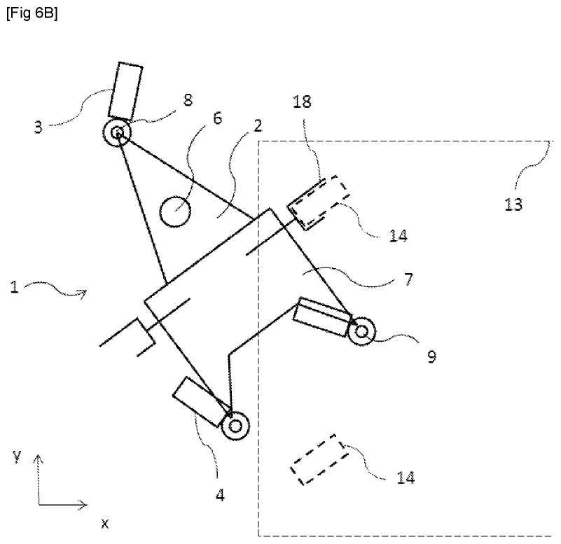

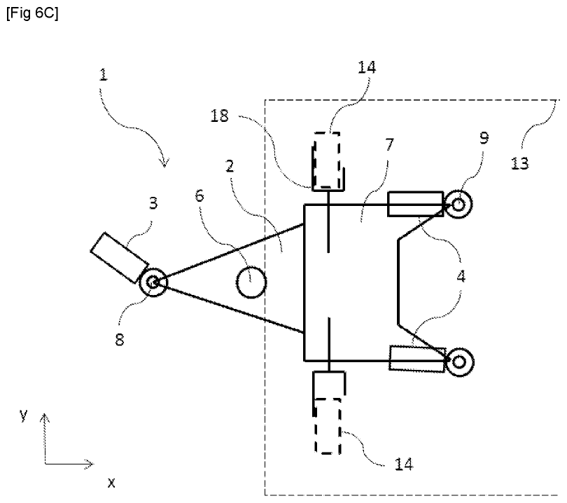

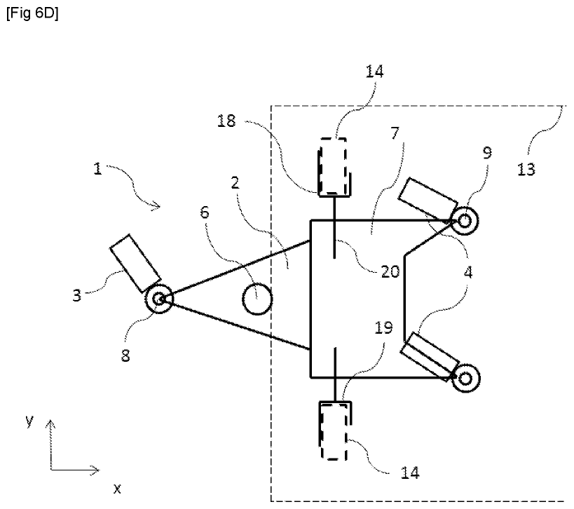

FIG. 6A schematically illustrates (in top view), by way of non-limitative example, the gripping sequence of an electric propulsion system 1 according to one or more embodiments of the invention by moving coupling means 5 close to a rear wheel 14 of rolling object 13 until the wheel of the rolling object is inserted between two grasping elements 18, the axis of rotation of rear wheel 14 being perpendicular to the principal axis of the two grasping elements 18. In this example, the distance between grasping elements 18 and the ground during the gripping sequence is substantially 0.5 times the diameter of wheel 14 of the rolling object and the distance between the two grasping elements is 8 cm, i.e. a distance greater than the thickness (6 cm) of wheel 14 of the rolling object. In this example, the grasping element 18 located on the side of (facing) motorized wheel 3 is longer than the grasping element 18 located on the side of non-motorized wheels 4. In this example, the grasping element 18 located on the side of motorized wheel 3 is 6 cm longer than the grasping element 18 located on the side of non-motorized wheels 4. Grasping element 18 may be a rod or a plate.

FIGS. 6B and 6C schematically illustrate (in top view), by way of non-limitative example, the orientation sequence of an electric propulsion system 1 according to one or more embodiments of the invention by rotating the gripped wheel 14 around its point of contact on the ground in order to orient this wheel 14 (gripped by grasping means 18) in a direction substantially perpendicular to the longitudinal direction of the chassis of the propulsion system. In this example, orientation is achieved through the rotation of electric propulsion system 1 around the vertical axis of gripped wheel 14 until this wheel 14 is arranged in a direction parallel to the lateral direction of chassis 2. As shown in FIGS. 6B and 6C, rotation of the gripped wheel 14 (itself linked to rolling object 13 by a vertical axis of rotation that does not pass through said point of contact) by electric propulsion system 1 has the effect of causing a slight displacement of rolling object 13. This displacement of rolling object 13 then causes rotation of a second wheel 14 of the rolling object around its point of contact with the ground. The rotation of second wheel 14 of the rolling object is similar to that imposed on the first rear wheel 14 (Caddy™ effect). In this example, the rotation of electric propulsion system 1 is applied until the second set of two grasping elements 18 comes into contact with said second wheel 14 of the rolling object. In this example, the directional movement of non-motorized wheels 4 of the structure is preferably left free.

FIG. 6D schematically illustrates (in top view), by way of non-limitative example, the immobilization sequence of an electric propulsion system 1 according to one or more embodiments of the invention by moving an immobilization branch 19, arranged between grasping elements 18, so as to contact and lock gripped wheels 14, for example by means of one or more cylinders such as electric cylinders, screw-nut systems, rack and pinion systems, or any similar means. In this example, immobilization branches 19 are arranged on the inner side of chassis 2 with respect to grasping elements 18. In this example, lashing arms 20 are spaced from one another (i.e. moved towards the outside of chassis 2, by means of cylinders for example) until immobilization branches 19 come into contact with and abut against gripped wheels 14. In this example, the directional movement of non-motorized wheels 4 of the structure is preferably left free.

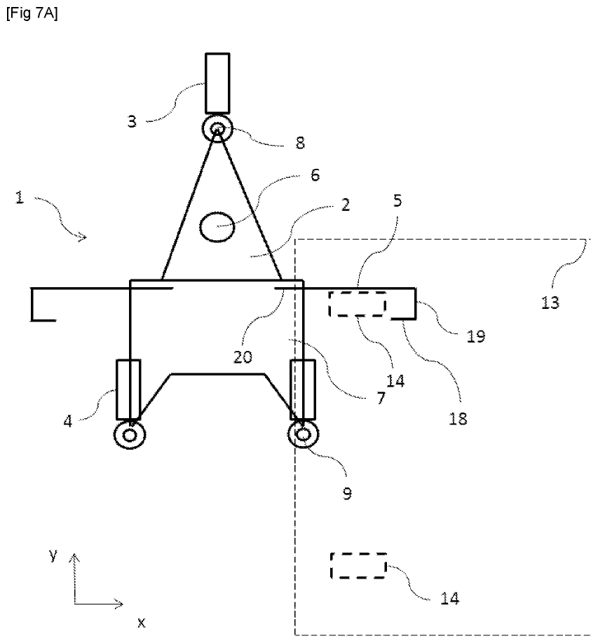

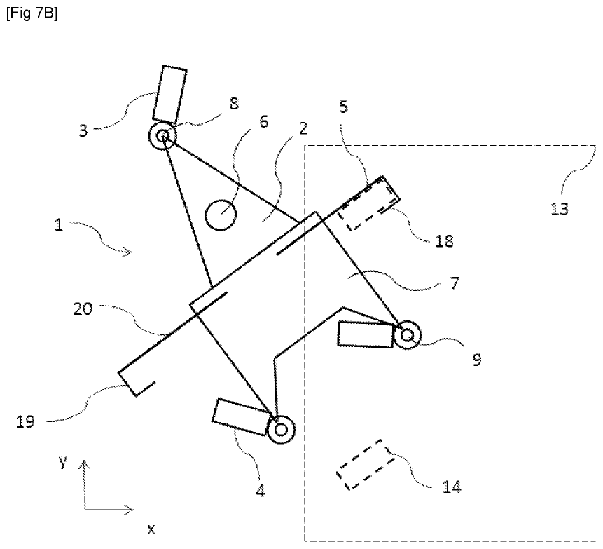

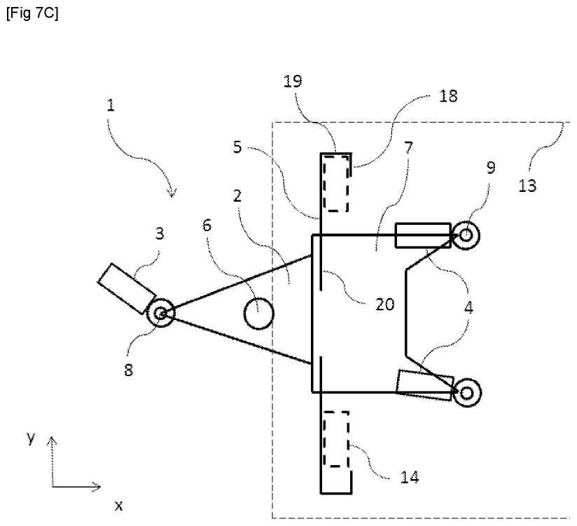

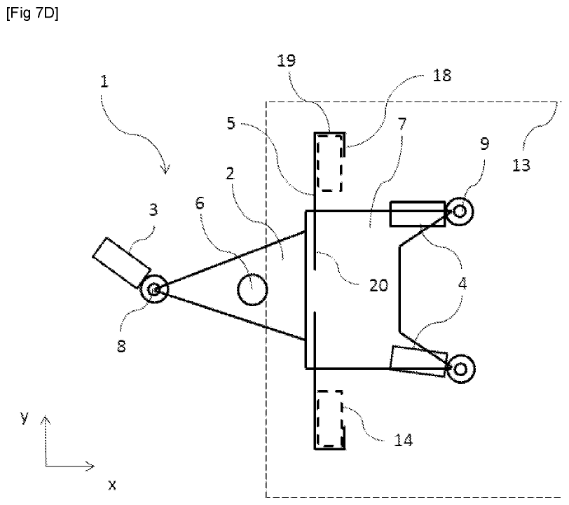

FIGS. 7A, 7B, 7C and 7D schematically illustrate (in top view), by way of non-limitative example, the gripping, orienting and immobilizing sequences similar to the sequences defined above in connection with FIGS. 6A, 6B, 6C and 6D, except that immobilization branches 19 are arranged on the outer side of chassis 2 with respect to grasping elements 18. In the example of FIG. 7A, the gripping sequence is not finished. Between FIGS. 7A and 7B, the user can generate a displacement of grasping elements 18 around wheel 14 to complete the gripping sequence, before, during or after the rotation sequence.

In the example of FIG. 7D, lashing arms 20 are brought close to one another (i.e. moved towards the inside of chassis 2, by means of cylinders for example) until immobilization branches 19 come into contact with and abut against gripped wheels 14. In these examples, the directional movement of non-motorized wheels 4 of the structure is preferably left free.

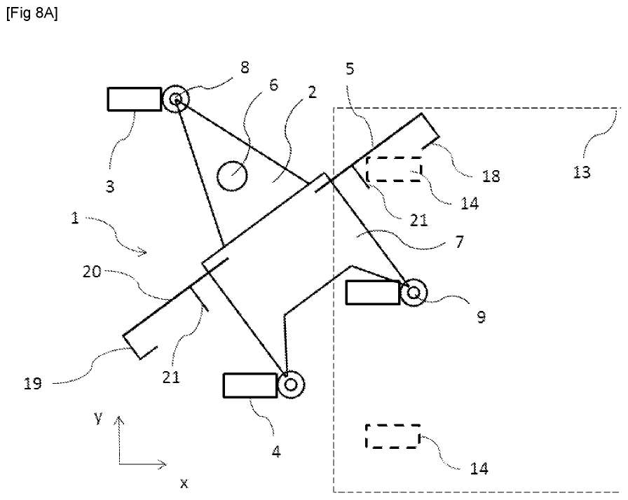

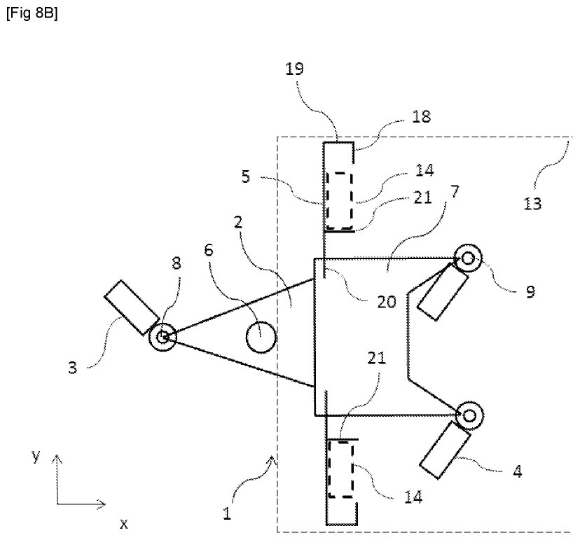

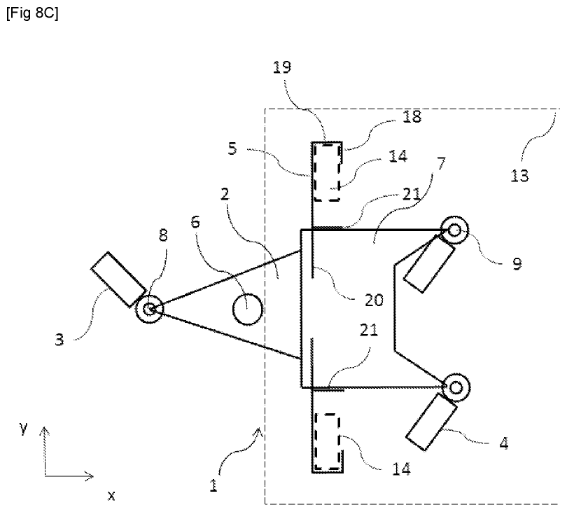

FIGS. 8A, 8B and 8C schematically illustrate (in top view), by way of non-limitative example, the gripping, orienting and immobilizing sequences similar to the sequences defined above in connection with FIGS. 7A, 7B, 7C and 7D, except that coupling means 5 comprise a stop element 21 arranged on the inner side of coupling means 5 with respect to grasping elements 18, stop element 21 being provided to guide wheel 14 of rolling object 13 in such a way that said wheel 14 abuts against grasping element 18 arranged on the side of motorized wheel 3. FIGS. 8A and 8B notably illustrate that grasping element 18 arranged on the side of motorized wheel 3 and stop element 21 allow to guide wheel 14 of rolling object 13 during the orientation sequence without requiring insertion of said wheel 14 between the two grasping elements 18. FIG. 8C illustrates the gripping and immobilization sequences ending simultaneously when lashing arms 20 are brought close to one another (i.e. moved towards the inside of chassis 2, by means of cylinders for example) until immobilization arms 19 come into contact with and abut against gripped wheels 14. In these examples, the directional movement of non-motorized wheels 4 of the structure is preferably left free.

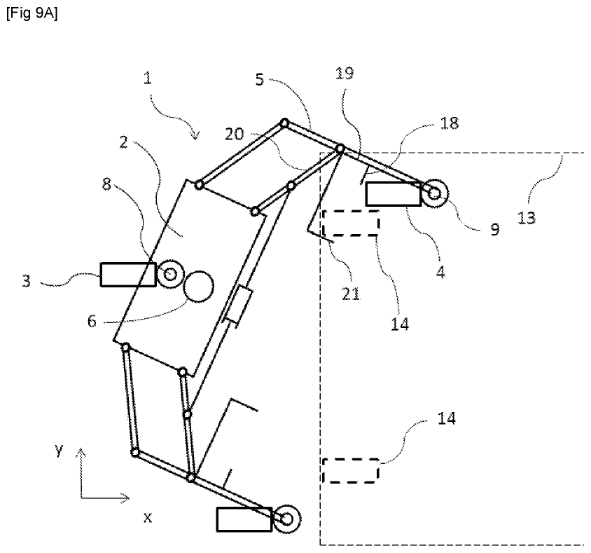

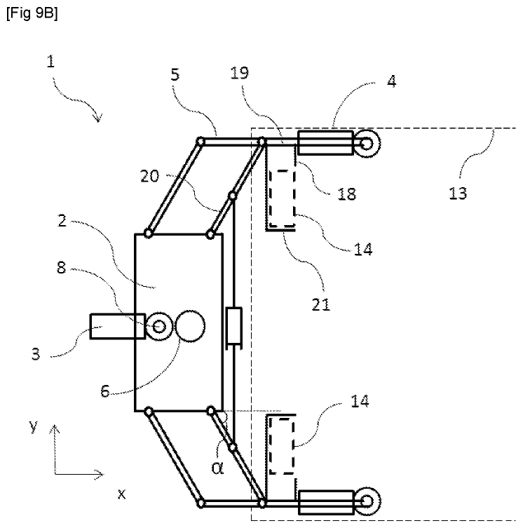

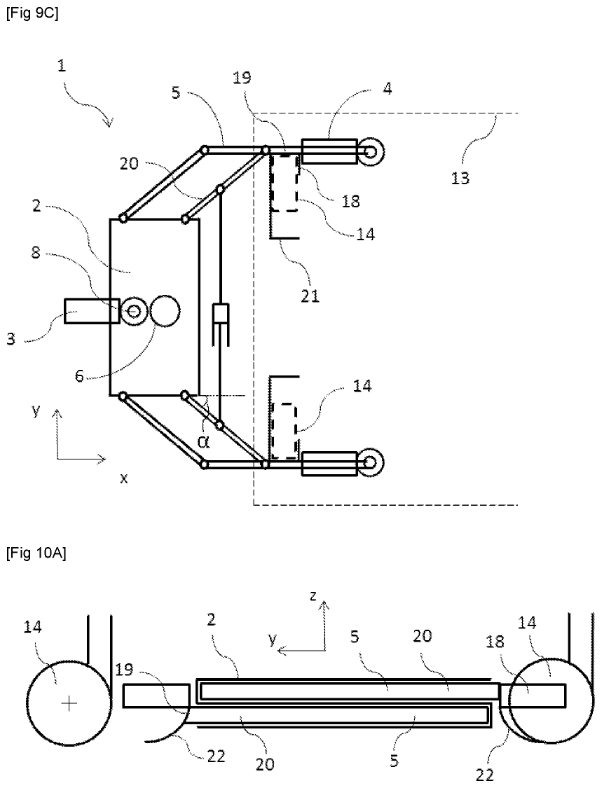

FIGS. 9A, 9B and 9C schematically illustrate (in top view), by way of non-limitative example, the gripping, orienting and immobilizing sequences similar to the sequences defined above in connection with FIGS. 8A, 8B and 8C, except that coupling means 5 are supported by non-motorized wheels 4 and immobilization branches 19 form a clamp system that can be tightened by a cylinder adapted to move lashing arms 20 close to one another by means of a rotational movement. In this example, lashing arms 20 are connected to one another and set in motion by a common actuator such as a cylinder. As shown in FIGS. 9B and 9C, each lashing arm is rotatably movable about a vertical pivot axis, the principal axis of a lashing arm forming, with respect to the longitudinal axis of the chassis (i.e. axis x), an angle α substantially greater than 45° at the end of the rotation sequence (FIG. 9B) and an angle α substantially smaller than 45° at the end of the immobilization sequence (FIG. 9C).

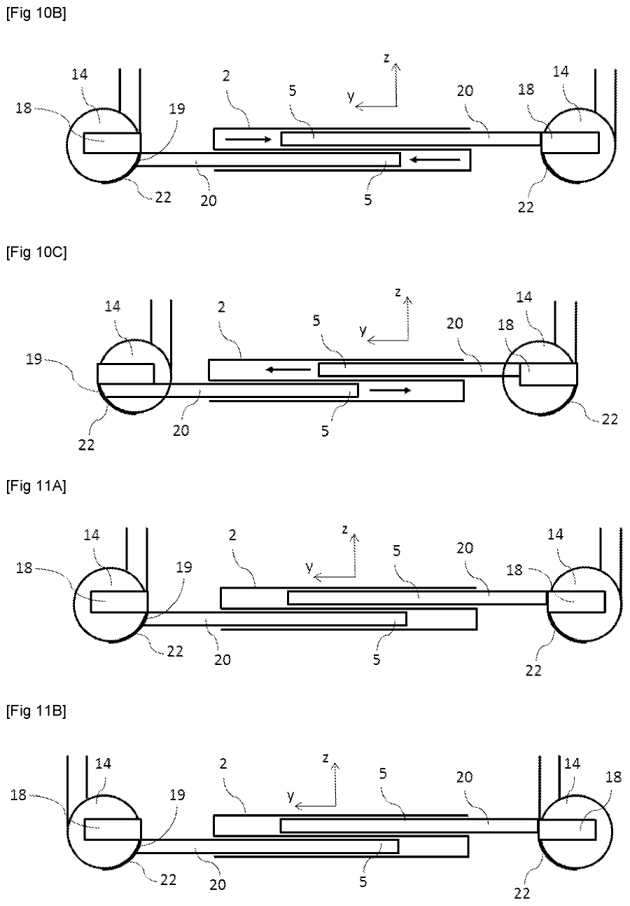

FIGS. 10A, 10B and 100 schematically illustrate (in side view in the transverse direction), by way of non-limitative example, the immobilization sequences similar to the sequences defined above in connection with FIGS. 6C, 6D and 7D respectively, wherein immobilization branches 19 comprise a support element 22 (a flat, inclined, curved or L-shaped piece adapted to pass under gripped wheel 14 and to support immobilized wheel 14). As shown in FIGS. 10B and 100, during the immobilization sequence, support element 22 is adapted to pass under gripped wheel 14 during the actuation of lashing arms 20 and thus to support immobilized wheel 14.

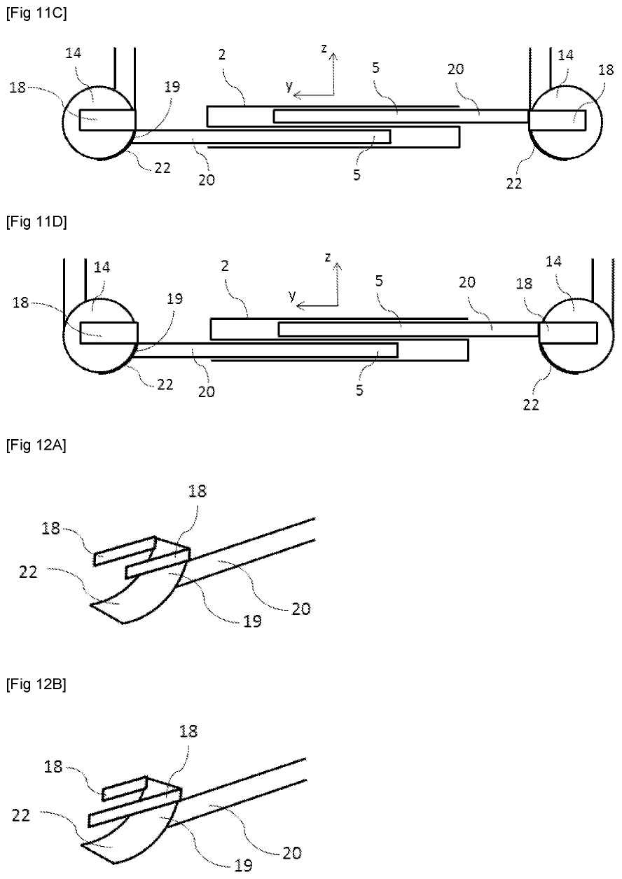

FIGS. 11A and 11B schematically illustrate (in side view in the transverse direction), by way of non-limitative example, immobilization sequences wherein immobilized wheels 14 are oriented in the same direction along the axis perpendicular to the longitudinal direction of the chassis (immobilization elements arranged in opposition). FIG. 11C schematically illustrates, by way of non-limitative example, an immobilization sequence wherein immobilized wheels 14 are oriented in different directions and arranged in opposition along the axis perpendicular to the longitudinal direction of the chassis. FIG. 11D schematically illustrates, by way of non-limitative example, an immobilization sequence wherein immobilized wheels 14 are oriented in different directions and arranged facing each other along the axis perpendicular to the longitudinal axis of the chassis. Although FIGS. 11A, 11B, 11C and 11D are illustrated with immobilization branches 19 arranged on the inner side of chassis 2 with respect to grasping elements 18, it is also possible to immobilize wheels 14 of the rolling object in the same direction, in opposition or facing each other with immobilization branches 19 arranged on the outer side of chassis 2 with respect to grasping elements 18.

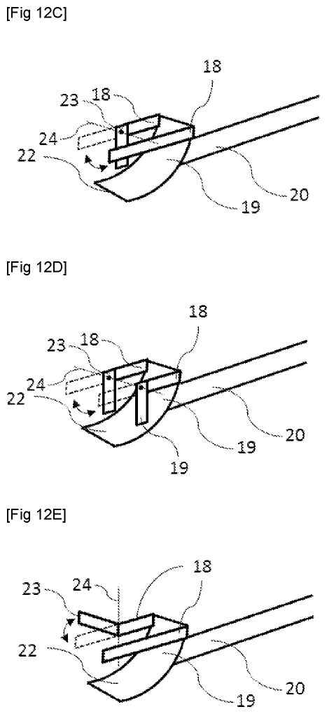

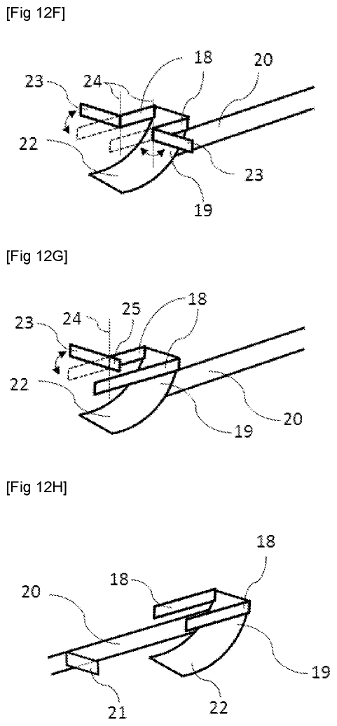

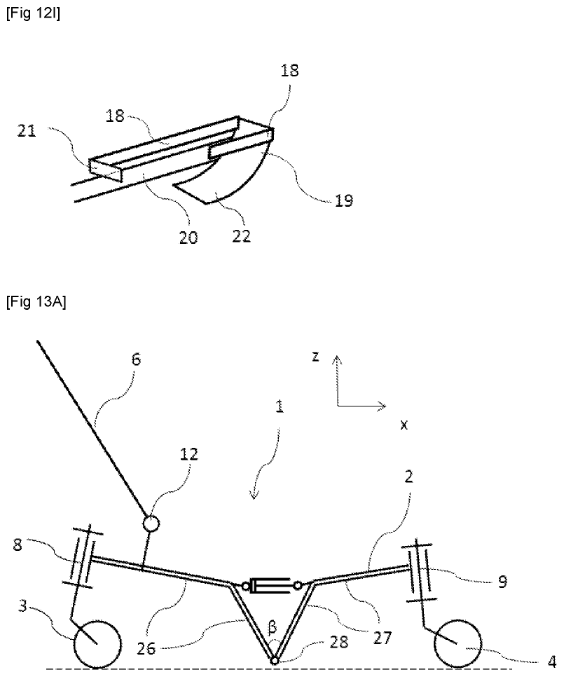

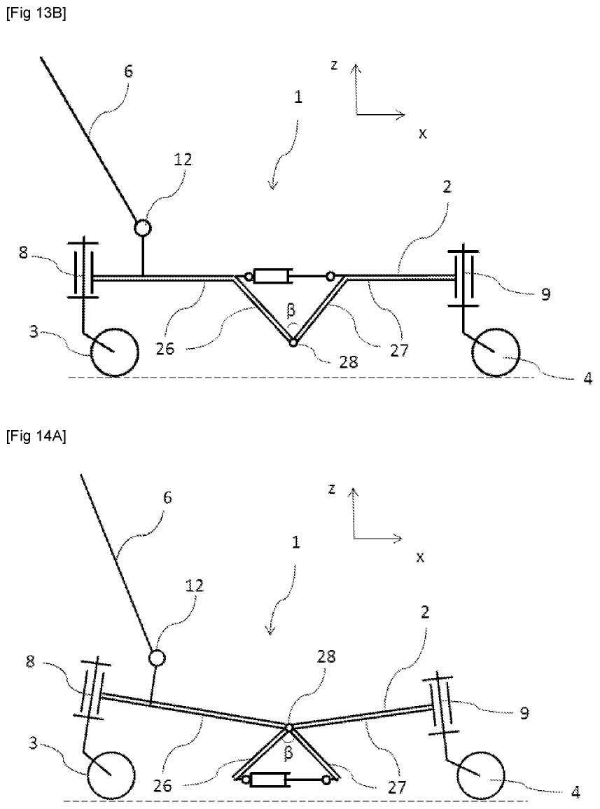

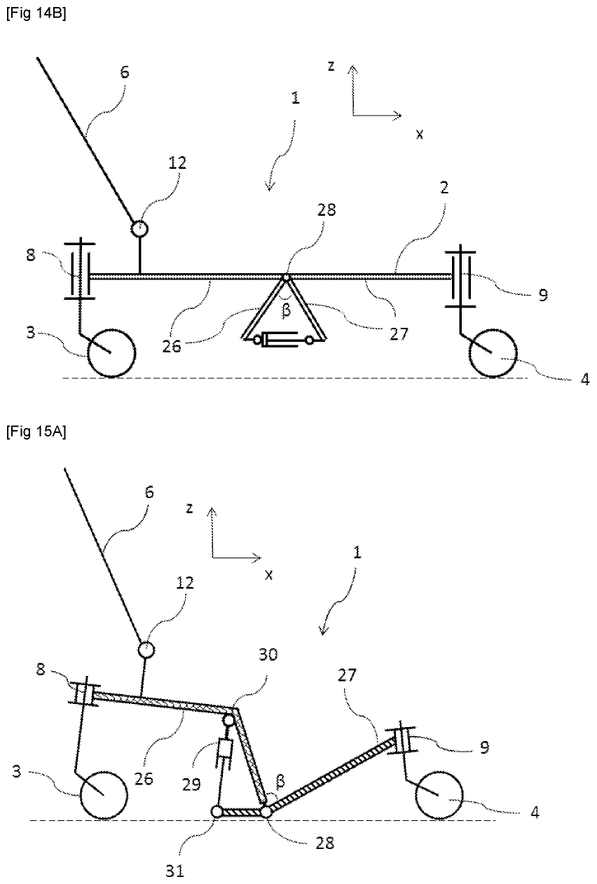

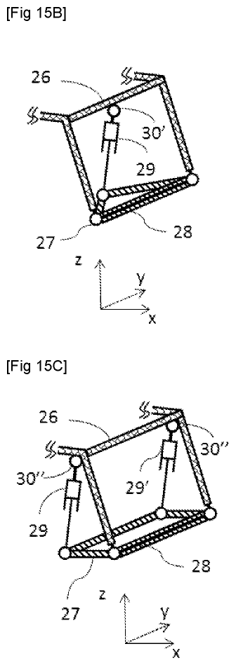

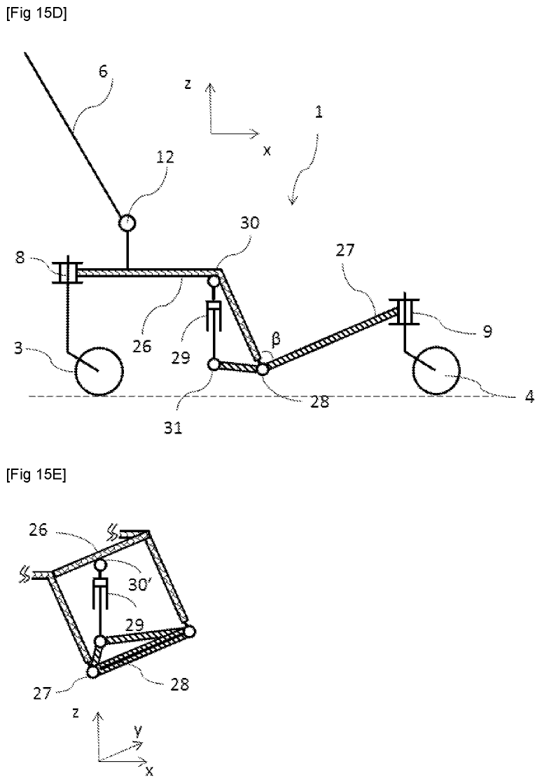

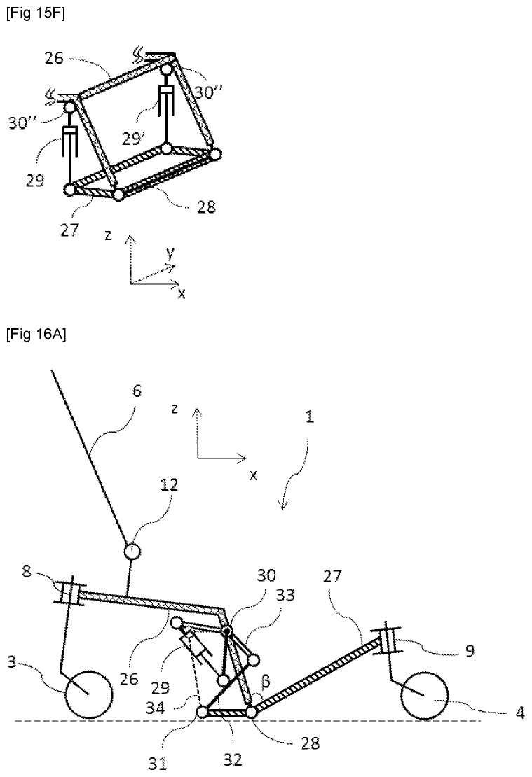

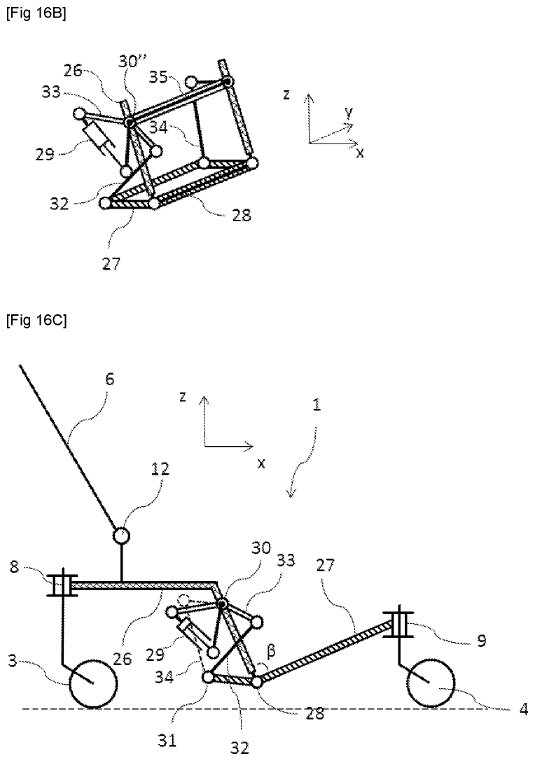

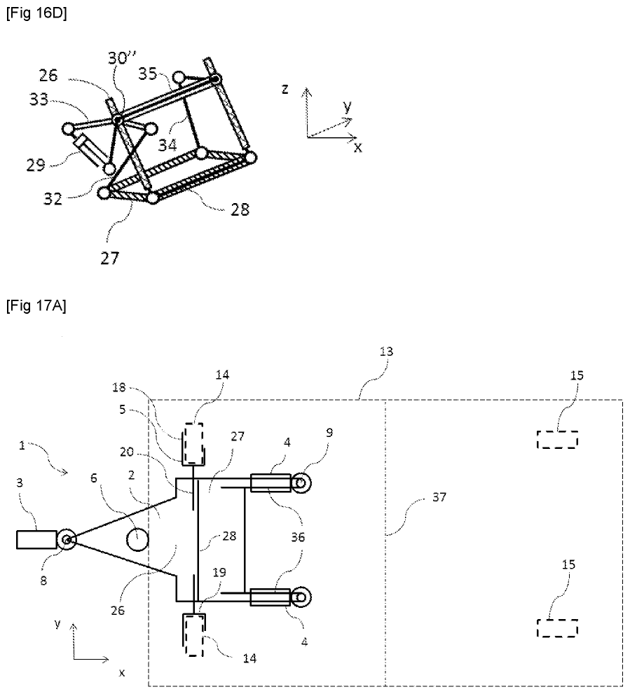

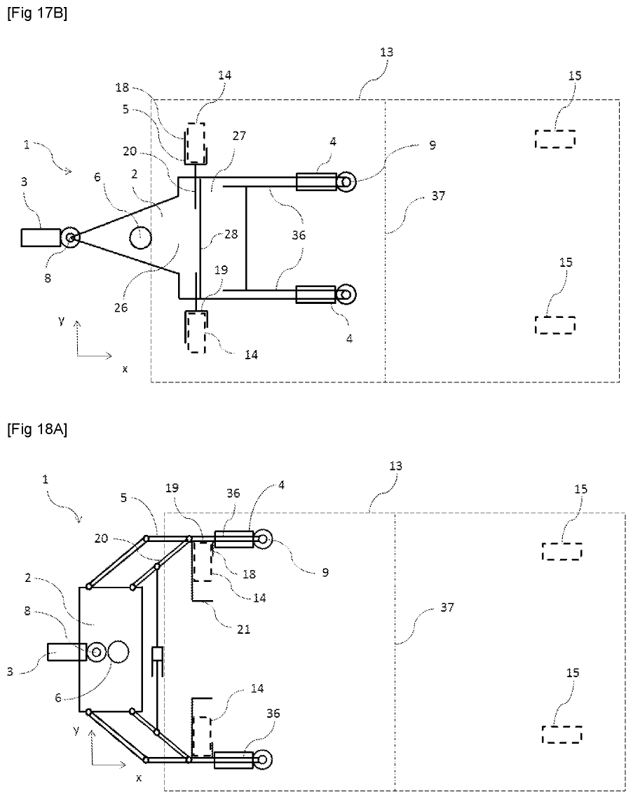

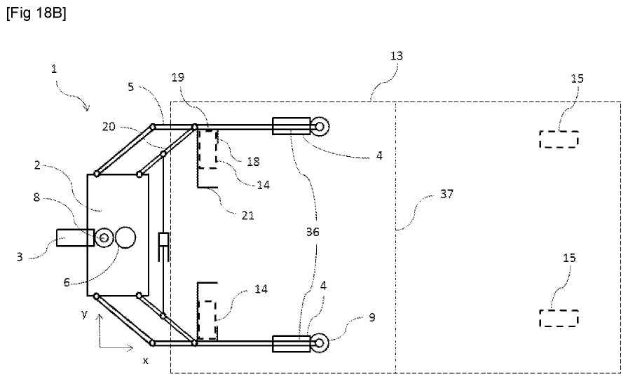

FIGS. 12A-121 schematically illustrate (in three-dimensional view), by way of non-limitative example, gripping and immobilizing means according to one or more embodiments. Specifically, FIG. 12A shows a lashing arm 20 comprising an immobilization branch 19 provided with a spoon-shaped or shovel-shaped support element 22, lashing arm 20 being extended by two grasping elements 18 of substantially identical length. FIG. 12B shows an example wherein one grasping element 18 is substantially longer than the other grasping element. Preferably, grasping element 18 arranged on the side of (closest to) motorized wheel 3 is substantially longer than grasping element 18 arranged on the side of non-motorized wheel(s) 4, thus facilitating the gripping sequence by acting as a guide when gripping wheel 14 of rolling object 13. FIGS. 12C-12G show examples wherein a moving part 23 such as a rod or a plate (e.g. metallic) is connected to at least one grasping element 18 through an axis of rotation 24, moving part 23 being arranged at the end of grasping element 18 opposite to immobilization branch 19. Moving part 23 allows to limit the size of grasping element 18 during the gripping sequence and facilitates holding of wheel 14 gripped between grasping elements 18 during the rotation sequence. In connection with FIGS. 12C and 12D, moving part 23 comprises a substantially vertical principal axis and axis of rotation 24 is parallel to the longitudinal direction of the chassis. Moving part 23 is preferably arranged downward with respect to grasping element 18 so as to increase the compactness of the coupling means. In connection with FIGS. 12E and 12F, moving part 23 comprises a substantially horizontal principal axis, it is parallel to the longitudinal direction of the chassis, arranged on the side opposite to adjacent grasping element 18 and comprises a vertical axis of rotation 24. In connection with FIG. 12G, moving part 23 as described in FIG. 12E further comprises an inner portion 25 arranged on the side facing adjacent grasping element 18. The length of the inner portion is strictly less than the distance between the two grasping elements 18 to allow insertion of gripped wheel 14 between grasping elements 18. Inner portion 25 notably allows to serve as a bearing point for the actuation of the moving part around the axis of rotation when wheel 14 of the rolling object abuts against said inner portion 25. FIG. 12H shows an example of a lashing arm 20 for coupling by external gripping wherein a stop element 21 is arranged on lashing arm 20. FIG. 121 shows an example of a lashing arm 20 for coupling by external gripping wherein stop element 21 is arranged on grasping element 18.

FIGS. 13A, 13B, 14A and 14B schematically illustrate (in side view in a lateral direction), by way of non-limitative example, lifting means in low position (FIGS. 13A and 14A) and in upper position (FIGS. 13B and 14B) according to one or more embodiments, comprising an articulated structure in the central part of the chassis (e.g. between the at least one motorized wheel and the at least one non-motorized wheel). The articulated structure comprises, on the one hand, a first chassis portion referred to as “motive portion 26” supported by the at least one motorized wheel 3, and it comprises, on the other hand, a second chassis portion referred to as “non-motorized portion 27” supported by at least one non-motorized wheel 4. Chassis portions 26 and 27 are articulated with respect to one another about a horizontal axis of rotation, referred to as “articulation axis 28”, substantially perpendicular to the longitudinal direction of the chassis. Electric propulsion system 1 performs the lifting sequence by actuating a first actuator so as to generate a substantially vertical upward displacement of articulation axis 28 by modifying the angle β between chassis portions 26 and 27 at articulation axis 28. In connection with FIGS. 13A and 13B, articulation axis 28 is arranged on a lower end of chassis portions 26 and 27, and angle β is increased to move from the lower position to the upper position.

FIGS. 15A to 15F schematically illustrate (FIGS. 15A and 15D in side view in a lateral direction, and FIGS. 15B, 15C, 15E and 15F in three-dimensional view), by way of non-limitative example, lifting means in lower position (FIGS. 15A, 15B and 15C) and in upper position (FIGS. 15D, 15E and 15F) according to one or more embodiments, wherein articulation axis 28 is located at a lower end of chassis portions 26 and 27, and angle β is increased to move from the lower position to the upper position. In this example, first actuator 29 is connected along the longitudinal axis of chassis 2 (i.e. along view xz in the figures), on the one hand, to a central portion 30 of motive portion 26 and, on the other hand, to a rear end portion 31 of non-motorized portion 27 (i.e. the end facing motive portion 26). In connection with FIGS. 15B and 15E, first actuator 29 can be a single actuator adjacent to a central portion 30′ according to a top view (along a substantially horizontal axis substantially perpendicular to the longitudinal direction of chassis 2) of chassis portions 26 and 27. Advantageously, a single lifting actuator is necessary. In connection with FIGS. 15C and 15F, first actuator 29 is assisted by an additional actuator 29′, each actuator being arranged adjacent to lateral end portions 30″ according to a top view (i.e. view xy in the figures) of motive portion 26. Advantageously, the lifting actuators are arranged on the sides of the chassis so as to free up space in the middle of the chassis and to obtain more compact coupling means.

FIGS. 16A to 16D schematically illustrate (FIGS. 16A and 16C in side view in a lateral direction, and FIGS. 16B and 16D in three-dimensional view), by way of non-limitative example, lifting means in lower position (FIGS. 16A and 16B) and in upper position (FIGS. 16C and 16D) according to one or more embodiments, wherein articulation axis 28 is located at a lower end of chassis portions 26 and 27, and angle β is increased to move from the lower position to the upper position. In this example, first actuator 29 is connected along the longitudinal axis of chassis 2 (i.e. along view xz in the figures), on the one hand, to a central portion 30 of motive portion 26 and, on the other hand, to a rear end portion 31 of non-motorized portion 27 (i.e. the end facing motive portion 26). In connection with FIGS. 16B and 16D, first actuator 29 is a single actuator adjacent to an end portion 30″ according to a top view (i.e. view xy in the figures) of chassis portions 26 and 27. Advantageously, a single lifting actuator is necessary and said actuator is arranged on the sides of the chassis so as to free up space in the middle of the chassis and to obtain more compact coupling means. In this example, first actuator 29 is adapted to: actuate, on the one hand, a crossed rod 32 connected to a first end of first actuator 29, for example by means of a gear 33; and to actuate, on the other hand, an uncrossed rod 34 connected to the second end of first actuator 29, for example by means of a shaft 35 running through central portion 30 (i.e. horizontal shaft perpendicular to the longitudinal direction of the chassis). One of said rods 32, 34 is connected along the longitudinal axis of chassis 2, at one end thereof, to a central portion 30 of first chassis portion 26 by means of gear 33, and at the other end thereof to a rear end portion 31 of non-motorized portion 27. In this example, crossed rod 32 is on the same side as actuator 29 and uncrossed rod 34 is connected to actuator 29 by means of shaft 35. It is also possible for uncrossed rod 34 to be on the same side as actuator 29 and for crossed rod 32 to be connected to actuator 29 by means of shaft 35.

In connection with FIGS. 16A to 16C, according to one or more embodiments, angle β is modified from 20° to 90°, preferably from 60° to 90°, between a lower position and an upper position of chassis portions 26 and 27.

FIGS. 17A and 17B schematically illustrate, by way of non-limitative example, drive assist means according to one or more embodiments adapted to assist the user in handling the coupled assembly and comprising two extendable arms 36 allowing to modify the distance between the at least one non-motorized wheel 4 and lashing arms 20. Each extendable arm 36 is, on the one hand, supported by non-motorized wheel 4 through vertical shaft 9 and, on the other hand, connected to non-motorized portion 27. Advantageously, extendable arms 36 allow non-motorized wheels 4 to be positioned as close as possible to central part 37 of the rolling object (in the longitudinal direction of the chassis), which results in increased maneuverability, referred to as “5th wheel effect”, notably upon rotation and/or displacement of the coupled assembly in cramped rooms and/or corridors, especially when the directional movement of said non-driven wheel 4 is locked. In connection with FIG. 17A, extendable arms 36 are in retracted position. In connection with FIG. 17B, when the electric propulsion system performs the drive assist sequence, the second actuator is actuated so as to lengthen extendable arms 36 and to increase the distance between non-motorized wheels 4 and lashing arms 20.

In all the figures, the coupling means are shown stationary in longitudinal position on the chassis. However, they could alternatively comprise adjusting means enabling adjustment in longitudinal position on the chassis or on the platform. The adjusting means can be independent for each coupling means, or allow simultaneous adjustment of the various coupling means. This adjusting means can notably be controlled by an operating device and the user can upon this operating device, using for example a remote control or a smartphone to control the displacement of one or more coupling means, in the longitudinal direction, towards the front or the rear of the electric propulsion system.

These adjusting means can notably be used when the wheels of the rolling object are not in the same orthogonal plane to the longitudinal axis of the rolling object (or of the chassis). They can also be useful to facilitate gripping of the wheels of the rolling object and contribute to the compactness of the coupled or non-coupled system.

FIGS. 18A and 18B schematically illustrate, by way of non-limitative example, drive assist means according to one or more embodiments similar to the drive assist means in connection with FIGS. 17A and 17B, except that wheels 14 of rolling object 13 are immobilized through external gripping and immobilization. Specifically, FIG. 18A shows extendable arms 36 in retracted position and FIG. 18B shows extendable arms 36 in extended position. Preferably, the directional movement of non-motorized wheels 4 of the structure is left free during the actuation of the actuator. Although FIGS. 18A and 18B show that coupling means 5 are supported by non-motorized wheels 4, it is also possible for coupling means 5 to achieve external gripping without being supported by the non-motorized wheels (see for example FIGS. 7A-8C).

In the present application, the term “comprise” is synonymous with (has the same meaning as) “include” and “contain”, it is open and inclusive, and it does not exclude other unrecited elements. It is understood that the term “comprise” includes the exclusive and closed term “consist”. Furthermore, in the present description, the terms “about”, “substantially”, “essentially”, “only” and “approximately” are synonymous by default with margin below and/or above 20%, preferably 10%, more preferably 5%, of the given value. For example, substantially perpendicular corresponds by default to an angle of 78° to 108°; substantially parallel corresponds by default to an angle of −18° to 18°; substantially vertical corresponds by default to vertical +/−18°; substantially horizontal corresponds by default to horizontal +/−18°.

1) A removable electric propulsion system for a rolling object, propulsion system comprising a chassis provided with at least one wheel driven by an electric machine, and at least one non-driven wheel, a handlebar, and means for coupling propulsion system to rolling object, the coupling means comprising means for gripping, orienting, immobilizing and lifting of at least one wheel of rolling object, propulsion system further comprising: drive assist means including at least one arm of variable length adapted to vary the distance between the at least one driven wheel and the at least one non-driven wheel.

2) A removable electric propulsion system as claimed in claim 1, wherein variable-length arm is, on the one hand, supported by non-driven wheel and, on the other hand, connected to chassis or connected to coupling means carrying an immobilization element.

3) A removable electric propulsion system as claimed in claim 1, wherein variable-length arm is substantially horizontal and comprises a principal axis substantially parallel to the longitudinal direction (x) of chassis.

4) A removable electric propulsion system as claimed in claim 3, comprising an actuator connected to said variable-length arm and to non-motorized portion for varying the length of the variable-length arm.

5) A removable electric propulsion system as claimed in claim 4, comprising directional locking means adapted to lock/unlock the rotation of non-motorized wheel about a vertical axis, wherein the directional movement of non-motorized wheel is adapted to be left free during the actuation of the actuator.

6) A removable electric propulsion system as claimed in claim 1, wherein the orienting means are adapted to orient the at least one wheel of rolling object in a direction substantially perpendicular to longitudinal direction (x) of chassis of propulsion system.

7) A removable electric propulsion system as claimed claim 1, wherein the gripping means comprise at least one set of two grasping elements whose principal axes are substantially perpendicular to longitudinal direction (x) of chassis, the two grasping elements being adapted to capture wheel of rolling object.

8) A removable electric propulsion system as claimed in claim 1, wherein the immobilizing means comprise a substantially horizontal lashing arm carrying an immobilization element at one end thereof.

9) A removable electric propulsion system as claimed in claim 8, wherein variable-length arm is adapted to vary the distance between the at least one non-driven wheel and lashing arm.

10) A removable electric propulsion system as claimed in claim 9, wherein variable-length arm is so adapted that the distance between the at least one non-driven wheel and lashing arm can be modified by at least 150 mm.

11) A removable electric propulsion system as claimed in claim 9, wherein variable-length arm is so adapted that the distance between the at least one non-driven wheel and lashing arm can be modified by a value ranging between 200 mm and 500 mm.

12) A removable electric propulsion system as claimed in claim 1, wherein the lifting means comprise an articulated structure in the central part of the chassis, between the at least one motorized wheel and the at least one non-motorized wheel.

13) A removable electric propulsion system as claimed in claim 1, wherein the coupling means comprise adjusting means enabling adjustment in longitudinal position, preferably, the adjusting means being controlled by an operating device.

14) A coupled assembly comprising a rolling object and an electric propulsion system as claimed in claim 1, rolling object being coupled to electric propulsion system by the coupling means.

15) A coupled assembly as claimed in claim 14, comprising directional locking means adapted to: unlock the rotation of non-motorized wheel about a vertical axis in order to actuate variable-length arm ; and/or to lock the rotation of non-motorized wheel about the vertical axis in order to move the coupled assembly.

16) A method for coupling a rolling object to an electric propulsion system as claimed in claim 1, comprising at least the following step: varying the distance between the at least one driven wheel and the at least one non-driven wheel by means of at least one variable-length arm.
